(19) United States
(12) Patent Application Publication
(10) Pub. No.: US 2026/0281603 A1
(43) Pub. Date: Sep. 17, 2026

(54) EAR-CLIP EARPHONES

(71) Applicant: SHENZHEN SHOKZ CO., LTD., Shenzhen (CN)

(72) Inventors: Lei ZHONG, Shenzhen (CN); Haochen LIU, Shenzhen (CN); Shiyu YU, Shenzhen (CN); Jiang XU, Shenzhen (CN); Weijie YUAN, Shenzhen (CN); Xiaobang WEN, Shenzhen (CN)

(73) Assignee: SHENZHEN SHOKZ CO., LTD., Shenzhen (CN)

(21) Appl. No.: 19/672,532

(22) Filed: May 8, 2026

Related U.S. Application Data
(63) Continuation of application No. PCT/CN2024/138267, filed on Dec. 10, 2024.

(30) Foreign Application Priority Data
Dec. 11, 2023 (CN) 202311701969.7
Feb. 6, 2024 (CN) 202410172377.9
Feb. 6, 2024 (WO) PCT/CN2024/076377
Feb. 6, 2024 (WO) PCT/CN2024/076378
Feb. 6, 2024 (WO) PCT/CN2024/076388
Feb. 6, 2024 (WO) PCT/CN2024/076389
Feb. 6, 2024 (WO) PCT/CN2024/076495

(51) Int. Cl. H04R 1/10; H04R 1/34

(52) U.S. Cl. CPC H04R 1/105; H04R 1/1016; H04R 1/345; H04R 2460/09

(57) ABSTRACT

One or more embodiments of the present disclosure relates to an ear-clip earphone. The ear-clip earphone includes a sound-generating portion, a abutment portion, and an ear hook. The ear hook is configured to bypass an antihelix and a helix of a user, and connect the sound-generating portion and the abutment portion. The ear hook has a first symmetry plane. A housing forms a first projection on the first symmetry plane. The abutment portion forms a second projection on the first symmetry plane. The ear hook forms a third projection on the first symmetry plane. A first tangent point exists between the first projection and the second projection. The first tangent point serves as a first feature point. A point on an inner contour curve of the third projection that is farthest away from the first feature point is defined as a second feature point.

### CROSS-REFERENCE TO RELATED APPLICATIONS

This application is a continuation of International Patent Application No. PCT/CN 2024/138267, filed on Dec. 10, 2024, which claims priority to the Chinese Patent Application No. CN202311701969.7, filed on Dec. 11, 2023, the International Application No. PCT/CN2024/076377, filed on Feb. 6, 2024, the International Application No. PCT/CN2024/076495, filed on Feb. 6, 2024, the International Application No. PCT/CN2024/076378, filed on Feb. 6, 2024, the International Application No. PCT/CN2024/076388, filed on Feb. 6, 2024, the International Application No. PCT/CN2024/076389, filed on Feb. 6, 2024, and the Chinese Patent Application No. CN2024101723779, filed on Feb. 6, 2024, the entire contents of each of which are hereby incorporated by reference.

### TECHNICAL FIELD

The present disclosure generally relates to a field of earphones, and in particular to ear-clip earphones.

### BACKGROUND

Earphones are widely used in people's daily lives. The earphones can be used with electronic devices such as mobile phones and computers to provide a sound playback function for a user. Ear-clip earphones are a new type of earphone. The ear-clip earphones are generally compact in size and may be clipped to a helix of a user for use. Moreover, the ear-clip earphones do not block an ear canal, thereby not only ensuring safety in outdoor scenarios, but also providing improved wearing comfort as compared with an in-ear earphone. Conventional ear-clip earphones are generally clipped to a helix of a user. However, ear sizes of different users may be different. To avoid the ear-clip earphones from squeezing the helix of the user in a wearing state, to make the ear-clip earphone applicable to a wider range of users, and to improve wearing comfort, a shape of an ear hook of the ear-clip earphones needs to be designed.

Therefore, the present disclosure provides a ear-clip earphone. A curve of the ear hook of the ear-clip earphone is designed so as to avoid pressing against the helix of the user in the wearing state, thereby improving wearing comfort while being suitable for users having different ear sizes.

### SUMMARY

One or more embodiments of the present disclosure provide an ear-clip earphone. The ear-clip earphone includes a sound-generating portion. The sound-generating portion is configured to be located in a concha cavity of a user and contact an inner wall of the concha cavity. The sound-generating portion includes a housing, a sound-generating assembly, and a sound outlet hole, a abutment portion, and an ear hook. The housing is provided with an accommodating chamber. The sound-generating assembly is accommodated in the accommodating chamber, and configured to convert an electrical signal into an audio signal. The sound outlet hole is located on the housing and configured to guide out a sound generated by the sound-generating assembly. The abutment portion is configured to abut against a back of an ear of the user, and a battery is disposed in the abutment portion. The ear hook is configured to bypass an antihelix and a helix of the user and connect the sound-generating portion and the abutment portion. The ear hook has a first symmetry plane. The housing forms a first projection on the first symmetry plane. The abutment portion forms a second projection on the first symmetry plane. The ear hook forms a third projection on the first symmetry plane. The third projection includes an inner contour curve. The first projection and the second projection are in contact with each other. The first projection and the second projection have a first common tangent between the first projection and the second projection. The first common tangent is tangent to the first projection and the second projection at a first tangent point. The first tangent point serves as a first feature point. Alternatively, the first projection and the second projection have an overlapping region. An outer contour of the first projection and an outer contour of the second projection have two intersection points, and a midpoint of a connecting line between the two intersection points serves as the first feature point. A point on the inner contour curve farthest from the first feature point serves as a second feature point, and a distance between the first feature point and the second feature point is from 16.5 millimeters (mm) to 20.5 mm. Alternatively, the distance between the first feature point and the second feature point is greater than or equal to 12 mm and less than 16.5 mm. By designing the distance between the first feature point and the second feature point, the ear hook can bypass ears of a relatively large proportion of users, so as to be suitable for users having different ear sizes. At the same time, the ear hook may have an appropriate overall dimension, thereby avoiding unstable clamping.

In some embodiments, a side of the first projection away from the third projection and a side of the second projection away from the third projection have a second common tangent. The second common tangent is tangent to the first projection at a second tangent point. The second common tangent is tangent to the second projection at a third tangent point. A connecting line between the second tangent point and the third tangent point is defined as a reference connecting line. In a direction defined by the reference connecting line, the abutment portion and the second feature point are located on a same side of the first feature point, such that a portion of the ear hook close to the abutment portion undergoes a relatively abrupt transition, and a portion of the ear hook close to the sound-generating portion changes relatively smoothly. In this way, the ear hook is asymmetrically arranged, enabling the ear hook to correspond to variations from the helix to a rear side of an auricle and to the concha cavity, thereby avoiding interference between the ear hook and the helix and improving wearing comfort of the ear-clip earphone.

In some embodiments, in the direction defined by the reference connecting line, the distance between the first feature point and the second feature point is from from 7.5 mm to 10 mm. Alternatively, the distance between the first feature point and the second feature point is greater than or equal to 5 mm and less than 7.5 mm. This configuration avoid interference between the ear hook and the ear of the user, thereby improving wearing comfort and clamping performance of the ear-clip earphone.

In some embodiments, a connecting line between the first feature point and the second feature point is defined as a first connecting line. An included angle between the first connecting line and the reference connecting line is from 45° to 60°, or the included angle between the first connecting line and the reference connecting line is greater than 60° and less than or equal to 70°, such that the second feature point is at a suitable position relative to the first feature point. Therefore, the ear hook can adapt to more different ear sizes, avoid interference with the ear, and ensure wearing comfort and clamping performance of the ear-clip earphone.

In some embodiments, a centroid of the second projection is defined as a third feature point. In the direction defined by the reference connecting line, the second feature point is farther away from the first feature point than the third feature point. Asymmetry of the ear hook ensures that the ear hook corresponds to variations from the helix to a rear side of the auricle and to the concha cavity, thereby avoiding interference between the ear hook and a front side and the rear side of the auricle and improving wearing comfort of the earphone.

In some embodiments, the connecting line between the first feature point and the second feature point is defined as the first connecting line. An included angle between a connecting line between the first feature point and the third feature point and the first connecting line is 45° to 65°. This configuration avoids interference between the portion of the ear hook adjacent to the sound-generating portion and the front side of the auricle, and to avoid interference between the portion of the ear hook adjacent to the abutment portion and an upper rear side of the auricle.

In some embodiments, the connecting line between the first feature point and the second feature point is defined as the first connecting line. A first auxiliary line is drawn through the second feature point toward a side biased toward the first projection. A first included angle between the first auxiliary line and the first connecting line has a first preset value range. An intersection point between the first auxiliary line and a curve segment of the inner contour curve that is connected to the first projection is defined as a fourth feature point. A connecting line between the fourth feature point and the second feature point is defined as a second connecting line. The first preset value range is from 27° to 37°. Alternatively, the first preset value range is greater than 37° and less than or equal to 50°. By setting the first preset value range, the sound-generating portion can be prevented from blocking an ear canal opening of the user, and interference between the sound-generating portion and a tragus, the antihelix, or the helix can be avoided.

In some embodiments, a length of the second connecting line is from 15.5 mm to 21.5 mm. Alternatively, the length of the second connecting line is greater than or equal to 12.00 mm and less than 15.5 mm. This configuration avoid interference between the sound-generating portion and the tragus of the user or the sound-generating portion being excessively close to, or even blocking, the ear canal opening. In addition, interference and compression between a portion of the inner contour curve corresponding to the second connecting line and a portion of the user's ear extending from the helix to the concha cavity can be avoided.

In some embodiments, a portion of the inner contour curve corresponding to the second connecting line has a first arc length. A ratio of the first arc length to the length of the second connecting line is defined as a first arc-chord ratio. The first arc-chord ratio is from 1.10 to 1.25, or the first arc-chord ratio is greater than or equal to 1.05 and less than 1.10, so as to avoid interference between the ear hook and the helix or the antihelix, and to prevent the ear hook from being excessively large in size, which would otherwise affect wearing performance and reduce portability.

In some embodiments, the portion of the inner contour curve corresponding to the second connecting line is defined as a first arc segment. A distance from the second connecting line to the first arc segment is not greater than 3.2 mm, or not greater than 7.5 mm, so as to prevent the ear hook from being excessively large and the overall size of the earphone from being excessively large, thereby ensuring wearing performance and portability.

In some embodiments, with the fourth feature point as a center, a second arc segment and a third arc segment are respectively determined on two sides of the fourth feature point. An arc length of the second arc segment and an arc length of the third arc segment are within a preset arc length range. A connecting line between an end of the second arc segment away from the fourth feature point and an end of the third arc segment away from the fourth feature point is defined as a third connecting line. An arc segment corresponding to the third connecting line has a second arc length. The preset arc length range is from 2.5 mm to 3.5 mm. A ratio of the second arc length to a length of the third connecting line is defined as a second arc-chord ratio. The second arc-chord ratio is from 1.26 to 1.44. By setting the preset arc length range, a pressure relief hole disposed on the arc segment corresponding to the third connecting line can have sufficient installation space, while preventing positional deviation of the pressure relief hole and ensuring directivity of the sound-generating portion. By setting the second arc-to-chord ratio, the arc segment corresponding to the third connecting line has sufficient concavity, such that the pressure relief hole disposed at the concave position is shielded by the auricle in a wearing state, while preventing a connection between the sound-generating portion and the ear hook from being excessively thin and adversely affecting connection strength.

In some embodiments, a second auxiliary line is drawn through the second feature point toward a side biased toward the second projection. A second included angle between the second auxiliary line and the first connecting line has a second preset value range. An intersection point between the second auxiliary line and a curve segment of the inner contour curve connected to the second projection is defined as a fifth feature point. A connecting line between the fifth feature point and the second feature point is defined as a fourth connecting line. The second preset value range is from 34° to 49°, or greater than or equal to 20° and less than 34°, so as to prevent the abutment portion from excessively pressing against the rear side of the auricle of the user and to avoid interference between the abutment portion and head skin tissue located behind the auricle.

In some embodiments, a length of the fourth connecting line is from 7.2 mm to 9.2 mm, such that the ear hook has an appropriate size, interference between the ear hook and the rear side of the auricle is avoided, and misalignment between the abutment portion located behind the auricle and the sound-generating portion located within the concha cavity is prevented, thereby ensuring clamping firmness and wearing stability of the ear-clip earphone.

In some embodiments, a portion of the inner contour curve corresponding to the fourth connecting line has a third arc length. A ratio of the third arc length to the length of the fourth connecting line is defined as a third arc-chord ratio. The third arc-chord ratio is from 1.11 to 1.24, or greater than 1.24 and less than or equal to 1.4, so as to avoid interference between the ear hook and the ear, while minimizing compression of head skin behind the auricle caused by the abutment portion and the ear hook.

In some embodiments, a parallel line parallel to the reference connecting line is drawn through the first feature point. An intersection point between the parallel line and a contour of the first projection serves as a sixth feature point. A distance between the first feature point and the sixth feature point is from 10.5 mm to 15.5 mm. Alternatively, the distance between the first feature point and the sixth feature point is greater than 15.5 mm and less than or equal to 17 mm, so as to prevent the sound-generating portion from pressing against the tragus, while providing an appropriate size of the sound-generating portion and improving sound output efficiency.

In some embodiments, the connecting line between the first feature point and the second feature point is defined as the first connecting line. A point on the first projection closest to the second feature point serves as a seventh feature point. A connecting line between the seventh feature point and the second feature point serves as a fifth connecting line. A length of the fifth connecting line is from 12 mm to 16 mm, and an included angle between the fifth connecting line and the first connecting line is from 12° to 26°, so as to avoid interference between the earphone and the ear of the user.

In some embodiments, an extension line of the fifth connecting line intersects the first projection at an eighth feature point. A connecting line between the seventh feature point and the eighth feature point is defined as a sixth connecting line. A curve segment of the first projection corresponding to the sixth connecting line has a fourth arc length. A ratio of the fourth arc length to a length of the sixth connecting line is defined as a fourth arc-chord ratio. The fourth arc-chord ratio is from 1.4 to 1.7. Alternatively, the fourth arc-chord ratio is greater than 1.7 and less than or equal to 2.0, such that the sound-generating portion is spherical or approximately spherical, thereby enabling a shape of the sound-generating portion to conform to the concha cavity and improving wearing comfort of the ear-clip earphone.

In some embodiments, a distance between the second feature point and the eighth feature point is from 27 mm to 30 mm. Alternatively, the distance between the second feature point and the eighth feature point is greater than or equal to 25 mm and less than 27 mm, so as to prevent the sound-generating portion from blocking the ear canal opening of the user, avoid interference between the sound-generating portion and the tragus or the antihelix, and ensure a desired sound listening effect for the user.

In some embodiments, the connecting line between the first feature point and the second feature point is defined as the first connecting line. A third auxiliary line is drawn through the second feature point toward the side biased toward the second projection. A third included angle between the third auxiliary line and the first connecting line has a third preset value range. The third auxiliary line and a contour of the second projection have at least one intersection point. An intersection point farthest from the second feature point among the at least one intersection point is defined as a ninth feature point. A connecting line between the second feature point and the ninth feature point is defined as a sixth connecting line. The third preset value range is from 18° to 20°. Alternatively, the third preset value range is greater than or equal to 15° and less than 18°. A length of the sixth connecting line is from 16 mm to 21 mm. Alternatively, the length of the sixth connecting line is greater than 21 mm and less than or equal to 23 mm, so as to prevent the abutment portion from excessively pressing against the ear and to avoid interference between the abutment portion and the head skin of the user.

In some embodiments, in the wearing state, a point on the sound-generating portion corresponding to the first feature point is covered by the concha cavity. The sound-generating portion cooperates with the abutment portion through the corresponding point and a region adjacent to the corresponding point to implement clamping of the ear-clip earphone.

In some embodiments, the ear hook includes a metal sheet and a flexible layer wrapping an outer side of the metal sheet. Two ends of the metal sheet in a length direction of the metal sheet are respectively connected to the housing and the abutment portion. A width dimension of the metal sheet is from 1 mm to 3 mm, and a thickness of the metal sheet is from 0.15 mm to 0.3 mm, such that the ear hook can maintain its shape during stretching and have sufficient supporting strength to ensure wearing performance of the ear-clip earphone.

In some embodiments, the metal sheet is provided with a bistable structure. The bistable structure is configured to enable the ear hook to have a first stable position and a second stable position. When the ear hook is in the first stable position, the first projection does not contact the second projection. When the ear hook is in the second stable position, the first projection contacts the second projection, thereby facilitating wearing or removal of the ear-clip earphone.

In some embodiments, the bistable structure includes a protruding portion and an abutting part. The abutting part abuts a protruding point of the protruding portion. The first stable position and the second stable position are formed when the abutting part abuts against two sides of the protruding point, respectively, thereby facilitating wearing or removal of the ear-clip earphone.

### BRIEF DESCRIPTION OF THE DRAWINGS

The present disclosure will be further described by way of exemplary embodiments. These exemplary embodiments will be described in detail with reference to the accompanying drawings. These embodiments are not limiting. In these embodiments, the same reference numerals denote the same structures, wherein:

FIG. 1 is a schematic diagram of an exemplary ear of a user according to some embodiments of the present disclosure.

FIG. 2 is a schematic diagram of an exemplary external contour of an earphone according to some embodiments of the present disclosure.

FIG. 3A and FIG. 3B are schematic diagrams of an exemplary earphone worn on ears of different sizes according to some embodiments of the present disclosure, respectively.

FIG. 4 is a schematic diagram of a projection of an exemplary earphone on a first symmetry plane according to some embodiments of the present disclosure.

FIG. 5 is a schematic diagram of another perspective view of an exemplary ear hook according to some embodiments of the present disclosure.

FIG. 6 is a schematic diagram of a projection of another exemplary earphone on a first symmetry plane according to some embodiments of the present disclosure.

FIG. 7 is a schematic diagram of an internal structure of an exemplary ear hook according to some embodiments of the present disclosure.

FIG. 8A is a schematic diagram of an exemplary earphone in a first stable position according to some embodiments of the present disclosure.

FIG. 8B is a schematic diagram of the exemplary earphone in a second stable position according to some embodiments of the present disclosure.

FIG. 9 is a schematic diagram of an exemplary bistable structure according to some embodiments of the present disclosure.

### DETAILED DESCRIPTION

To more clearly illustrate the technical solutions of the embodiments of the present disclosure, the drawings used in the description of the embodiments are briefly introduced below. Obviously, the drawings in the following description are merely some examples or embodiments of the present disclosure. For a person of ordinary skill in the art, without creative efforts, the present disclosure can also be applied to other similar scenarios based on these drawings. It should be understood that these exemplary embodiments are provided only to enable a person skilled in the relevant art to better understand and implement the present disclosure, and are not intended to limit the scope of the present disclosure in any way. Unless obviously obtained from the context or the context illustrates otherwise, the same numeral in the drawings refers to the same structure or operation.

As shown in the present disclosure and the claims, unless the context clearly indicates an exception, the words “a”, “an”, “one”, and/or “the” are not limited to singular, but may also include plural. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements. The term “based on” means “based at least in part on.” The term “one embodiment” means “at least one embodiment”; the term “another embodiment” means “at least one other embodiment”.

In the description of the present disclosure, it should be understood that the orientation or positional relationships indicated by terms such as “front”, “rear”, and “ear hook” are based on the orientation or positional relationships shown in the drawings. The orientation or positional relationships are used only to facilitate the description of the present disclosure and simplify the description, and are not intended to indicate or imply that the device or element must have a specific orientation or be constructed and operated in a specific orientation. Therefore, the orientation or positional relationships should not be construed as limiting the present disclosure.

Furthermore, the terms “first” and “second” are used for descriptive purposes only, and should not be construed as indicating or implying relative importance or implicitly indicating the number of the indicated technical features. Thus, features defined with “first” and “second” may explicitly or implicitly include at least one such feature. In the description of the present disclosure, the meaning of “a plurality of” is at least two, such as two, three, etc., unless otherwise explicitly and specifically defined.

In the present disclosure, unless otherwise explicitly specified and defined, terms such as “install”, “connected”, “connect”, and “fixed” should be understood broadly. For example, the connection may be a fixed connection, a detachable connection, or an integral connection. The connection may be a mechanical connection, an electrical connection, or a direct connection. The connection may also be an indirect connection through an intermediate medium, an internal communication between two elements, or an interaction relationship between two elements, unless otherwise explicitly defined.

For a person of ordinary skill in the art, the specific meanings of the above terms in the present disclosure can be understood according to specific situations.

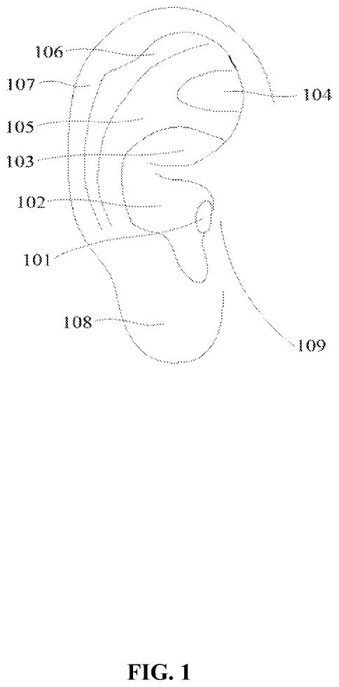

FIG. 1 is a schematic diagram of an exemplary ear of a user according to some embodiments of the present application. As shown in FIG. 1, an ear 100 may include an ear canal opening 101, a concha cavity 102, a cymba conchae 103, a triangular fossa 104, an antihelix 105, a scaphoid fossa 106, a helix 107, an earlobe 108, and a tragus 109. In some embodiments, an auricle (or referred to as a pinna) may be a collective term for other external ear parts of the ear 100 except the ear canal opening 101. For example, as shown in FIG. 1, the auricle may include the concha cavity 102, the cymba conchae 103, the triangular fossa 104, the antihelix 105, the scaphoid fossa 106, the helix 107, the earlobe 108, and the tragus 109. In some embodiments, wearing and stabilization of an acoustic device (e.g., an earphone) may be achieved by using one or more parts of the ear 100. In some embodiments, parts such as the ear canal opening 101, the concha cavity 102, the cymba conchae 103, and the triangular fossa 104 have a certain depth and volume in three-dimensional space, and may also be used to meet wearing requirements of the acoustic device. For example, an acoustic device (e.g., an in-ear earphone) may be worn in the ear canal opening 101. In some embodiments, wearing of the acoustic device may also be achieved by using other parts (i.e., the auricle) of the ear 100 except the ear canal opening 101. For example, wearing of the acoustic device may be achieved by using the cymba conchae 103, the triangular fossa 104, the antihelix 105, the scaphoid fossa 106, the helix 107, or a combination thereof. In some embodiments, to improve comfort and reliability of the acoustic device in wearing, the earlobe 108 or other parts of the user may be further used. By using other parts (i.e., the auricle) of the ear 100 except the ear canal opening 101 to achieve wearing of the acoustic device and propagation of sound, the ear canal opening 101 of the user can be “liberated”, and the impact of the acoustic device on the health of the ear of the user can be reduced. When the user wears the acoustic device on a road, the acoustic device does not block the ear canal opening 101 of the user. The user can receive sound from the acoustic device and sound (e.g., horn sounds, bicycle bell sounds, surrounding human voices, traffic command sounds, etc.) from an environment. Therefore, a probability of traffic accidents can be reduced. For example, when the user wears the acoustic device, the entire or a portion of a structure of the acoustic device may be located at a front side of the tragus 109. As another example, when the user wears the acoustic device, the entire or a portion of the structure of the acoustic device may contact an upper portion of the ear canal opening 101 (e.g., location(s) of one or more parts such as the tragus 109, the cymba conchae 103, the triangular fossa 104, the antihelix 105, the scaphoid fossa 106, and the helix 107). As yet another example, when the user wears the acoustic device, the entire or a portion of the structure of the acoustic device may be located in one or more parts of the ear (e.g., the concha cavity 102, the cymba conchae 103, the triangular fossa 104, etc.).

The description of the ear 100 above is for illustrative purposes only and is not intended to limit the scope of the present disclosure. For a person of ordinary skill in the art, various changes and modifications may be made according to the description of the present disclosure. For example, for different users, the structure, shape, size, thickness, etc. of one or more parts in the ear 100 may be different. As another example, a portion of the structure of the acoustic device may cover part or all of the ear canal opening 101. These changes and modifications still fall within the protection scope of the present disclosure.

Different users may have individual differences, resulting in dimensional differences such as different shapes and sizes of the ear 100. For ease of description and understanding, unless otherwise specified, the present disclosure mainly uses an auricle model with a “standard” shape and size as a reference to further describe a wearing manner of the acoustic device in different embodiments on the auricle model. For example, a simulator containing a head and its (left and right) ears 100 manufactured based on ANSI:S3.36, S3.25, and IEC: 60318-7 standards, such as GRAS 45BC KEMAR, may be used as a reference for wearing the acoustic device to present a scenario in which most users normally wear the acoustic device. In the present disclosure, descriptions such as “the user wears”, “in a wearing state”, and “in the wearing state” may refer to the acoustic device described in the present disclosure being worn on the ear 100 of the aforementioned simulator. Certainly, considering individual differences among different users, the structure, shape, size, thickness, etc., of one or more parts in the ear 100 may be designed differently according to different shapes and sizes of the ear 100. These differentiated designs may be manifested as characteristic parameters of one or more parts of the acoustic device having numerical values in different ranges to adapt to different ears 100. In addition, it should be noted that: a “non-wearing state” is not limited to a state in which the acoustic device is not worn on the ear 100 of the user, but also includes a state in which the acoustic device is not deformed by an external force. The “wearing state” is not limited to a state in which the acoustic device is worn on the ear 100 of the user. A state in which various components (e.g., the abutment portion, the ear hook, and the housing of the sound-generating portion, etc.) of the acoustic device are spread out to the same state as when worn (e.g., the various components maintain corresponding distances) may also be regarded as the wearing state.

It should be noted that: in fields such as medicine and anatomy, three basic planes of a human body, namely a sagittal plane, a coronal plane, and a horizontal plane, and three basic axes, namely a sagittal axis, a coronal axis, and a vertical axis, may be defined. The sagittal plane refers to a plane that is perpendicular to the ground and made along an anteroposterior direction of the human body. The sagittal plane divides the human body into a left part and a right part. The coronal plane refers to a plane that is perpendicular to the ground and made along a left-right direction of the human body. The coronal plane divides the human body into a front part and a rear part. The horizontal plane refers to a plane that is parallel to the ground and made along an up-down direction of the human body. The horizontal plane divides the human body into an upper part and a lower part. Correspondingly, the sagittal axis refers to an axis along the anteroposterior direction of the human body and perpendicular to the coronal plane. The coronal axis refers to an axis along the left-right direction of the human body and perpendicular to the sagittal plane. The vertical axis refers to an axis along the up-down direction of the human body and perpendicular to the horizontal plane. Furthermore, a “front side of the auricle” described in the present disclosure is a concept relative to a “rear side of the auricle” or a “back of the auricle”. The front side of the auricle refers to a side of the auricle away from the head, and the rear side of the auricle refers or the back of the auricle refers to to a side of the auricle facing toward the head, both sides are defined relative to the auricle of the user. By observing the auricle of the aforementioned simulator along a direction of the coronal axis of the human body, a schematic diagram of a front contour of the auricle as shown in FIG. 1 can be obtained.

The description of the ear 100 above is for illustrative purposes only and is not intended to limit the scope of the present disclosure. For a person of ordinary skill in the art, various changes and modifications can be made according to the description of the present disclosure. For example, a portion of the structure of the acoustic device may cover part of or the entire ear canal opening 101. These changes and modifications still fall within the protection scope of the present disclosure.

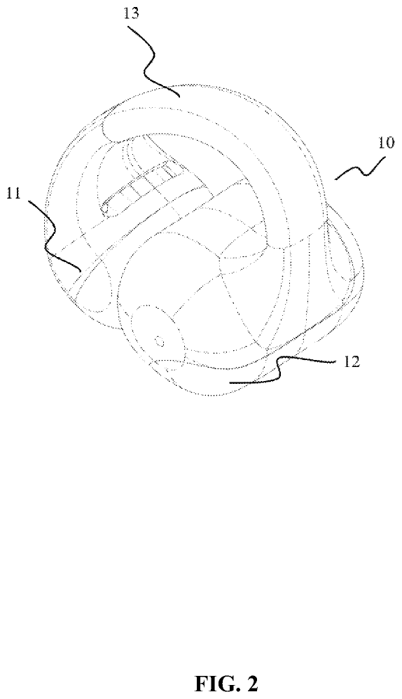

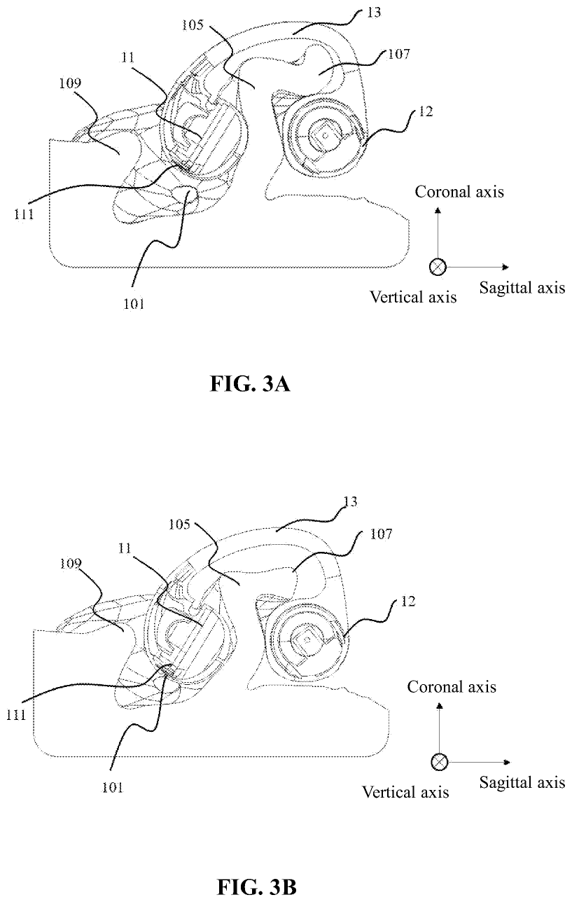

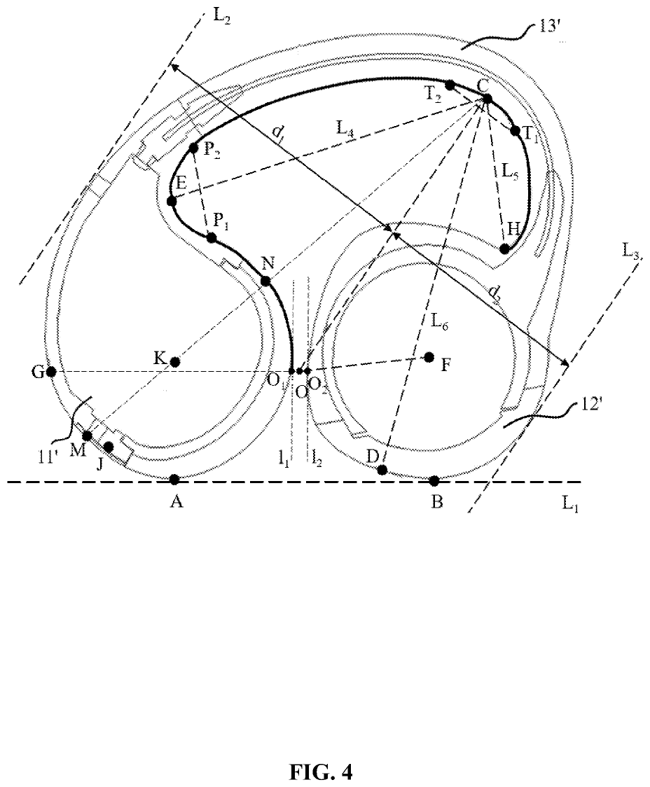

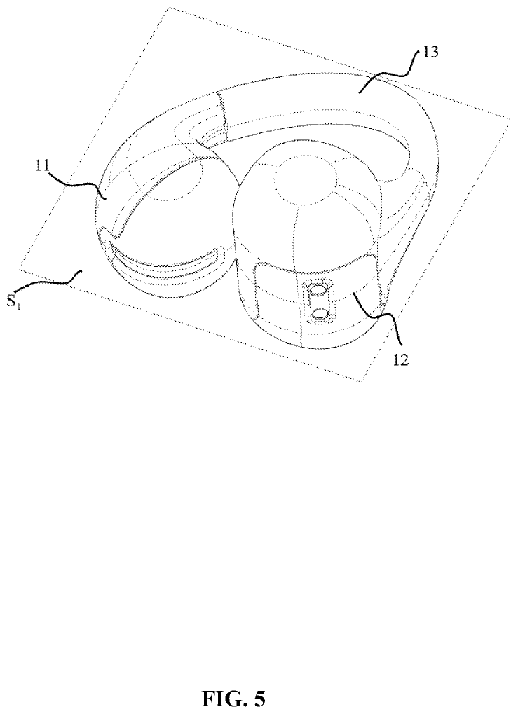

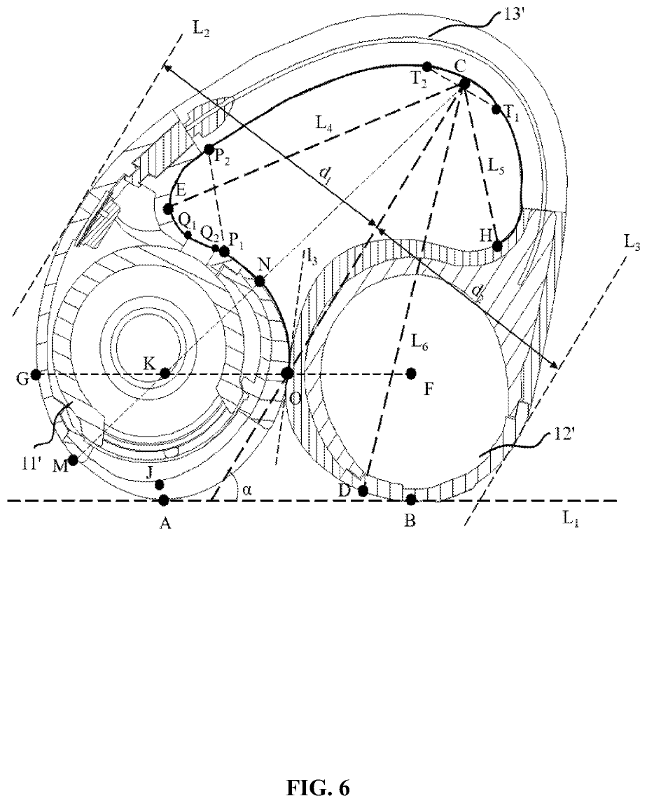

FIG. 2 is a schematic diagram of an exemplary external contour of an earphone according to some embodiments of the present disclosure. FIG. 3A and FIG. 3B are schematic diagrams of an exemplary earphone worn on ears of different sizes according to some embodiments of the present disclosure, respectively. FIG. 4 is a schematic diagram of a projection of an exemplary earphone on a first symmetry plane according to some embodiments of the present disclosure. FIG. 5 is a schematic diagram of another perspective view of an exemplary ear hook according to some embodiments of the present disclosure. FIG. 6 is a schematic diagram of a projection of another exemplary earphone on a first symmetry plane according to some embodiments of the present disclosure. An ear-clip earphone is described below with reference to FIG. 1 to FIG. 6.

Referring to FIG. 2, FIG. 3A, and FIG. 3B, in some embodiments, an ear-clip earphone 10 (hereinafter referred to as the earphone 10) mainly includes a sound-generating portion 11, a abutment portion 12, and an ear hook 13. The sound-generating portion 11 is configured to be inserted into the concha cavity 102 of a user and contact an inner wall of the concha cavity 102. The abutment portion 12 is configured to abut against a back of the ear of the user. The ear hook 13 is configured to connect the sound-generating portion 11 and the abutment portion 12. The earphone 10 is clamped through contact between the sound-generating portion 11, the abutment portion 12, and the ear. In some embodiments, the sound-generating portion 11 is a sound playback device. The sound-generating portion 11 is configured to convert an electrical signal into an audio signal and play the audio signal to the user. The abutment portion 12 and the sound-generating portion 11 form a clamping state to clamp and wear the entire earphone 10 near a helix of the ear of the user. In some embodiments, the abutment portion 12 may serve as a battery compartment for installing a battery or other components. In other embodiments, the abutment portion 12 may not serve as the battery compartment, and the battery may be installed in the sound-generating portion 11.

In some embodiments, the sound-generating portion 11 includes a housing (not labeled in the drawings) and a sound-generating assembly (not labeled in the drawings). An accommodating chamber (not labeled in the drawings) is provided in the housing. The sound-generating assembly is accommodated in the accommodating chamber. The sound-generating assembly is a module capable of converting an electrical signal into an audio signal, for example, a speaker. In some embodiments, a count of speakers in the sound-generating assembly may be one, two, or more. In some embodiments, a sound outlet hole 111 may be provided on the housing. The sound outlet hole 111 is configured to guide out a sound generated by the sound-generating assembly. In some embodiments, in a wearing state, the sound outlet hole 111 may be oriented toward the ear canal opening 101 of the user, as shown in FIG. 3A and FIG. 3B, so that the sound generated by the sound-generating assembly is directly transmitted to the ear canal opening 101, enhancing a sound listening effect at the ear canal opening 101 of the user.

Referring to FIG. 3A and FIG. 3B, ear sizes of different users may be different. For example, a helix of the ear of the user shown in FIG. 3A is relatively large, and a helix of the ear of the user shown in FIG. 3B is relatively small. To enable the earphone 10 to be suitable for users with different ear sizes and to avoid the ear hook 13 from squeezing the helix of the user in the wearing state, a curve of the ear hook 13 may be designed.

In some embodiments, the ear hook 13 may be symmetrically arranged. The ear hook 13 has a first symmetry plane S₁. In some embodiments, in the wearing state as shown in FIG. 3A and FIG. 3B, the first symmetry plane S₁ may be parallel to the horizontal plane (i.e., a plane of the paper shown in FIG. 3A and FIG. 3B). In some embodiments, the first symmetry plane S₁ may be located at a midpoint position in a width direction of the ear hook 13. The first symmetry plane S₁ may divide the ear hook 13 along a length direction of the ear hook 13 (i.e., an extension direction from an end of the ear hook 13 connected to the sound-generating portion 11 to an end of the ear hook 13 connected to the abutment portion 12) into two parts that are located on two sides of the first symmetry plane S₁ and are symmetrical to each other.

In some embodiments, the housing of the sound-generating portion 11 forms a first projection 11′ on the first symmetry plane S₁. The abutment portion 12 forms a second projection 12′ on the first symmetry plane S₁. The ear hook 13 forms a third projection 13′ on the first symmetry plane S₁. In some embodiments, the first projection 11′ has a lowest point A. The second projection 12′ has a lowest point B. The first projection 11′ and the second projection 12′ have a common tangent L₁ passing through the point A and the point B. The tangent L₁ is tangent to the first projection 11′ at the point A. The tangent L₁ is tangent to the second projection 12′ at the point B.

For ease of understanding, the following description uses an example where the earphone 10 is placed on the horizontal plane and the first symmetry plane S₁ is perpendicular to the horizontal plane. A contact point between the sound-generating portion 11 and the horizontal plane is the point A. A contact point between the abutment portion 12 and the horizontal plane is the point B. That is to say, the sound-generating portion 11 is tangent to the horizontal plane at the point A, and the abutment portion 12 is tangent to the horizontal plane at the point B. At this time, a line L₁ where the point A and the point B are located in FIG. 4 and FIG. 6 may be regarded as a projection of the horizontal plane on the first symmetry plane S₁. The line L₁ is tangent to the first projection 11′ at the point A and tangent to the second projection 12′ at the point B simultaneously. The first symmetry plane S₁ is parallel to a plane where the paper shown in FIG. 4 and FIG. 6 is located.

In some embodiments, the third projection 13′ includes an inner contour curve and an outer contour curve. The inner contour curve corresponds to a contour on a side of the ear hook 13 close to the helix in the wearing state. The outer contour curve corresponds to another contour on a side of the ear hook 13 away from the helix in the wearing state. On the first projection 11′, with the point A as a boundary point, a part connected to the inner contour curve of the third projection 13′ is an inner contour (also referred to as an inner contour curve) of the first projection 11′. A part connected to the outer contour curve of the third projection 13′ is an outer contour of the first projection 11′. On the second projection 12′, with the point B as a boundary point, a part connected to the inner contour curve of the third projection 13′ is an inner contour of the second projection 12′. A part connected to the outer contour curve of the third projection 13′ is an outer contour of the second projection 12′. In some embodiments, with the point A and the point B as boundaries, the inner contour of the first projection 11′, the inner contour of the third projection 13′, and the inner contour of the second projection 12′ are sequentially connected to jointly constitute an inner contour of the earphone 10. The outer contour of the first projection 11′, the outer contour of the third projection 13′, and the outer contour of the second projection 12′ are sequentially connected to jointly constitute an outer contour of the earphone 10.

Referring to FIG. 4, in some embodiments, when the sound-generating portion 11 and the abutment portion 12 are in a non-contact structure (as shown in FIG. 4), a shortest connecting line exists between the first projection 11′ and the second projection 12′. The shortest connecting line is a connecting line between two points that are closest to each other between the first projection 11′ and the second projection 12′. In some embodiments, two endpoints of the shortest connecting line are located on the inner contour of the first projection 11′ and the inner contour of the second projection 12′, respectively. That is to say, the shortest connecting line between the first projection 11′ and the second projection 12′ is located between the inner contour of the first projection 11′ and the inner contour of the second projection 12′. In some embodiments, a point O₁ is taken on the inner contour of the first projection 11′, and a tangent l₁ passing through the point O₁ on the inner contour of the first projection 11′ is determined. A point O₂ is taken on the inner contour of the second projection 12′, and a tangent l₂ passing through the point O₂ on the inner contour of the second projection 12′ is determined. When the tangent l₁ is parallel to the tangent l₂, and a connecting line between the point O₁ and the point O₂ is perpendicular to the tangent l₁ and the tangent l₂, the connecting line between the point O₁ and the point O₂ is the shortest connecting line between the inner contour of the first projection 11′ and the inner contour of the second projection 12′, i.e., the shortest connecting line between the first projection 11′ and the second projection 12′.

In some embodiments, the shortest connecting line between the first projection 11′ and the second projection 12′ may also be determined through tools, programs, etc. For example, by inputting contour curve parameters (e.g., a simulated curve function of the inner contour of the earphone 10, a simulated curve function of the outer contour of the earphone 10, etc.) of the earphone 10, corresponding tools, programs, etc., may output information (e.g., a position, endpoints, etc.) of the shortest connecting line between the first projection 11′ and the second projection 12′.

In some embodiments, when the sound-generating portion 11 and the abutment portion 12 have the non-contact structure, as shown in FIG. 4, the shortest connecting line between the first projection 11′ and the second projection 12′ (i.e., the shortest connecting line O₁O₂) has a midpoint O. The midpoint O serves as a first feature point. A position of the first feature point O may be used to reflect a fitting region between the sound-generating portion 11 and the abutment portion 12 and the ear of the user in the wearing state, thereby reflecting the wearing state of the earphone 10, facilitating determination of position postures of the sound-generating portion 11 and the abutment portion 12 in the wearing state, and facilitating subsequent design of the ear hook 13.

In other embodiments, when the sound-generating portion 11 and the abutment portion 12 are in a contact structure, as shown in FIG. 6, a fitting region or a fitting point exists between the first projection 11′ and the second projection 12′. A center point (e.g., a centroid, an area center, etc.) of the fitting region or the fitting point may serve as the first feature point O. In some embodiments, when the sound-generating portion 11 contacts the abutment portion 12, the inner contour of the first projection 11′ and the inner contour of the second projection 12′ are fitted. At this time, a common tangent l₃ may be determined on the inner contour of the first projection 11′ and the inner contour of the second projection 12′. The common tangent l₃ is tangent to the inner contour of the first projection 11′ and the inner contour of the second projection 12′ at a first tangent point O simultaneously. The first tangent point O may serve as the first feature point. In some embodiments, when a contact region between the sound-generating portion 11 and the abutment portion 12 is a surface, a centroid of a projection of the contact surface on the first symmetry plane S₁ is the first feature point O. In some embodiments, when the sound-generating portion 11 and the abutment portion 12 are in a contact structure, a side of the first projection 11′ away from the third projection 13′ and a side of the second projection 12′ away from the third projection 13′ have a common tangent (i.e., the common tangent L₁). A second tangent point between the common tangent L₁ and the first projection 11′ is the point A. A third tangent point between the common tangent L₁ and the second projection 12′ is the point B. A connecting line between the point A and the point B (i.e., a connecting line AB, a line L₁) may be used as a reference connecting line L₁.

In some embodiments, the first projection 11′ and the second projection 12′ have an overlapping region. In the overlapping region, the outer contour of the first projection 11′ and the outer contour of the second projection 12′ have two intersection points. A midpoint of a connecting line between the two intersection points serves as the first feature point O. It should be noted that, when the overlapping region exists between the first projection 11′ and the second projection 12′, the sound-generating portion 11 and the abutment portion 12 may be in a contact structure, or the sound-generating portion 11 and the abutment portion 12 may also be in a non-contact structure. For example, in some embodiments, the abutment portion 12 forms a recessed region recessed toward an interior of the abutment portion 12. The first symmetry plane S₁ passes through the recessed region. At least a partial region of the sound-generating portion 11 is embedded in the recessed region, so that projections of the abutment portion 12 and the sound-generating portion 11 on the first symmetry plane S₁ have the overlapping region, i.e., so that the overlapping region exists between the first projection 11′ and the second projection 12′. In some embodiments, the sound-generating portion 11 embedded in the recessed region may be configured to abut against or contact the abutment portion 12. In some embodiments, the sound-generating portion 11 embedded in the recessed region may also be configured not to abut against or contact the abutment portion 12.

In some embodiments, when the sound-generating portion 11 and the abutment portion 12 are in a non-contact structure, an endpoint of the shortest connecting line O₁O₂ on the first projection 11′ is the point O₁. In the wearing state, a corresponding point of the point O₁ on the sound-generating portion 11 is covered by the concha cavity, i.e., the corresponding point of the point O₁ on the sound-generating portion 11 is located near a contact point between the sound-generating portion 11 and the user's concha cavity in the wearing state. In other words, the sound-generating portion 11 cooperates with the abutment portion 12 through the corresponding point of the point O₁ (and a region near the corresponding point) to achieve clamping of the earphone 10.

Correspondingly, when the sound-generating portion 11 and the abutment portion 12 are in a contact structure, in the wearing state, a corresponding point of the first feature point O on the sound-generating portion 11 is covered by the concha cavity, i.e., the corresponding point of the point O on the sound-generating portion 11 is located near the contact point between the sound-generating portion 11 and the user's concha cavity in the wearing state. In other words, the sound-generating portion 11 cooperates with the abutment portion 12 through the corresponding point of the point O (and a region near the corresponding point) to achieve clamping of the earphone 10.

In some embodiments, the inner contour curve of the third projection 13′ has at least one point C that is farthest from the first feature point O. In some embodiments, if there are a plurality of points farthest from the first feature point O, a point among the plurality of farthest points that is closest to the second projection 12′ of the abutment portion 12 may serve as a second feature point C. The second feature point C may be determined by a tool, a program, or the like. For example, by inputting the contour curve parameters of the earphone 10 (e.g., the simulated curve function of the inner contour of the earphone 10, the simulated curve function of the outer contour of the earphone 10, etc.), a corresponding tool, program, or the like may determine information of the first feature point O, thereby outputting information (e.g., a position) of the second feature point C.

In some embodiments, as shown in FIG. 3, in the wearing state, the point O is located near the contact point between the sound-generating portion 11 and the concha cavity, the helix is located within a region enclosed by an inner contour of the ear hook 13, and the helix is substantially located in a region on the inner contour of the ear hook 13 that is farthest from the point O. To enable the earphone 10 to bypass the ear of the user without squeezing or interfering with the ear, by designing the first feature point O and the second feature point C, the ear hook 13 of the earphone 10 can bypass a larger proportion of users' ears in the wearing state, making the earphone 10 suitable for a wider range of population.

If a distance between the first feature point O and the second feature point C is too small, the ear hook 13 may squeeze or interfere with the helix of a larger user population in the wearing state, affecting wearing comfort and a clamping effect. If the distance between the first feature point O and the second feature point C is too large, an overall size of the ear hook 13 may become too large, and the earphone 10 may easily experience unstable clamping.

In some embodiments, when the abutment portion 12 and the sound-generating portion 11 are in a non-contact structure, to enable the ear hook 13 to bypass a larger proportion of users' ears while giving the ear hook 13 a suitable size and avoiding unstable clamping, the distance between the first feature point O and the second feature point C (i.e., a length of a line segment OC shown in FIG. 4) may be from 16 mm to 20 mm. In some embodiments, to further adapt the ear hook 13 to more ear sizes, the distance between the first feature point O and the second feature point C may be from 16.5 mm to 19 mm. In some embodiments, to avoid an excessively large size of the ear hook 13 and avoid unstable clamping, the distance between the first feature point O and the second feature point C may be from 16.7 mm to 18 mm. For example, the distance between the first feature point O and the second feature point C may be 17.0 mm.

In some embodiments, when the abutment portion 12 and the sound-generating portion 11 are in a contact structure, the distance between the first feature point O and the second feature point C may be from 16.5 mm to 20.5 mm. For example, the distance between the first feature point O and the second feature point C may be 17.3 mm. In some embodiments, when the abutment portion 12 and the sound-generating portion 11 are in a contact structure, the distance between the first feature point O and the second feature point C may also be set to be greater than or equal to 12 mm and less than 16.5 mm. For example, the distance between the first feature point O and the second feature point C may be set to 12 mm, 13 mm, 15 mm, 16.2 mm, or other actual values greater than or equal to 12 mm and less than 16.5 mm.

In some embodiments, when the abutment portion 12 and the sound-generating portion 11 are configured as a structure enabling the first projection 11′ and the second projection 12′ to have an overlapping region, the distance between the first feature point O and the second feature point C may also be set to 16.5 mm to 20.5 mm, or set to be greater than or equal to 12 mm and less than 16.5 mm. For example, the distance between the first feature point O and the second feature point C may be set to 12 mm, 13 mm, 15 mm, 16.2 mm, or other actual values greater than or equal to 12 mm and less than 16.5 mm. As another example, the distance between the first feature point O and the second feature point C may be set to 16.5 mm, 17 mm, 17.3 mm, 20.5 mm, or other actual values within the range of 16.5 mm to 20.5 mm.

Referring to FIG. 4 and FIG. 6, in some embodiments, when the sound-generating portion 11 and the abutment portion 12 are in a non-contact structure, in a direction of the shortest connecting line O₁O₂, the second feature point C and the abutment portion 12 are located on a same side of the first feature point O. In some embodiments, in the wearing state, the second feature point C may correspond to a position of a point on the helix that is farthest from the concha cavity. The design of the position of the second feature point C causes a portion of the ear hook 13 near the abutment portion 12 to undergo a more abrupt change, while a change in a portion of the ear hook 13 near the sound-generating portion 11 is relatively smooth. That is to say, on the third projection 13′, a rate of change from the second feature point C to the inner contour curve of the second projection 12′ is significantly greater than a rate of change to the inner contour curve of the first projection 11′, so that the ear hook 13 is asymmetrically arranged. As shown in FIG. 3A and FIG. 3B, a change gradient from the concha cavity to the helix on a front side of the auricle is significantly smaller than a change gradient from the helix to a back of the concha cavity on a rear side of the auricle. To better adapt to this change of the auricle, by asymmetrically arranging the ear hook 13, the ear hook 13 may correspond to changes from the helix to the back of the auricle and to the concha cavity, thereby avoiding interference between the ear hook 13 and the helix, and improving wearing comfort of the earphone 10.

In some embodiments, when the sound-generating portion 11 and the abutment portion 12 are in a non-contact structure, the shortest connecting line O₁O₂ may be parallel or approximately parallel to the connecting line AB. That is to say, a direction of a straight line where the shortest connecting line O₁O₂ lies may also be replaced by a direction defined by the reference connecting line L₁. Correspondingly, when the sound-generating portion 11 and the abutment portion 12 are in a contact structure, in the direction defined by the reference connecting line L₁, the second feature point C and the abutment portion 12 are located on the same side of the point O. Correspondingly, when the abutment portion 12 and the sound-generating portion 11 are configured as a structure where the first projection 11′ and the second projection 12′ have an overlapping region, in the direction defined by the reference connecting line L₁, the second feature point C and the abutment portion 12 are located on the same side of the point O.

In some embodiments, when the sound-generating portion 11 and the abutment portion 12 are in a non-contact structure, by adjusting positions of and the distance between the first feature point O and the second feature point C in the direction of the straight line where the shortest connecting line O₁O₂ lies, a design requirement for the second feature point C deviating from the first feature point O may be satisfied, so that the ear hook 13 may correspond to changes from the helix to the back of the auricle and to the concha cavity, thereby avoiding the interference between the ear hook 13 and the helix, and improving the wearing comfort of the earphone 10.

If, in the direction of the shortest connecting line O₁O₂, the distance between the first feature point O and the second feature point C (i.e., a projection length of a line segment OC on the straight line where the shortest connecting line O₁O₂ lies) is too large, it indicates that the deviation of the second feature point C from the first feature point O is too large. With the second feature point C as a boundary, a portion of the ear hook 13 near the abutment portion 12 is too small. In the wearing state, the portion of the ear hook 13 near the abutment portion 12 may interfere with a portion of the rear side of the auricle of the ear. If the distance between the first feature point O and the second feature point C in the direction of the shortest connecting line O₁O₂ is too small, the second feature point C deviates from the first feature point O too little. With the second feature point C as a boundary, a portion of the ear hook 13 close to the sound-generating portion 11 is too small. In the wearing state, the portion of the ear hook 13 close to the sound-generating portion 11 may interfere with a portion of the front side of the auricle of the ear. Interference between the ear hook 13 and the ear may affect wearing comfort and the clamping effect of the earphone 10.

In some embodiments, when the sound-generating portion 11 and the abutment portion 12 are in a non-contact structure shown in FIG. 4, to avoid interference between the ear hook 13 and the ear of the user and to improve the wearing comfort and the clamping effect of the earphone 10, in the direction of the shortest connecting line O₁O₂, the distance between the first feature point O and the second feature point C may be from 8.2 mm to 11 mm. In some embodiments, to further reduce a possibility of interference between the ear hook 13 and the front side of the auricle, in the direction of the shortest connecting line O₁O₂, the distance between the first feature point O and the second feature point C may be from 8.7 mm to 10.5 mm. In some embodiments, to further reduce the possibility of interference between the ear hook 13 and the rear side of the auricle, in the direction of the shortest connecting line O₁O₂, the distance between the first feature point O and the second feature point C may be from 9 mm to 10 mm. For example, in the direction of the shortest connecting line O₁O₂, the distance between the first feature point O and the second feature point C may be 9.9 mm.

Correspondingly, when the sound-generating portion 11 and the abutment portion 12 are in a contact structure shown in FIG. 6, in the direction defined by the reference connecting line L₁, the distance between the first feature point O and the second feature point C may be from 7.5 mm to 10 mm. For example, in the direction defined by the reference connecting line L₁, the distance between the first feature point O and the second feature point C may be 9.1 mm. In some embodiments, to avoid interference between the ear hook 13 and the ear of the user and to improve the wearing comfort and the clamping effect of the earphone 10, when the sound-generating portion 11 and the abutment portion 12 are in the contact structure shown in FIG. 6, in the direction defined by the reference connecting line L₁, the distance between the first feature point O and the second feature point C may be set to be greater than or equal to 5 mm and less than 7.5 mm. For example, the distance between the first feature point O and the second feature point C may be set to 5 mm, 6 mm, 7 mm, or other actual values greater than or equal to 5 mm and less than 7.5 mm.

In some embodiments, to avoid interference between the ear hook 13 and the ear of the user and to improve the wearing comfort and the clamping effect of the earphone 10, when the abutment portion 12 and the sound-generating portion 11 are in a structure where the first projection 11′ and the second projection 12′ have an overlapping region, in the direction defined by the reference connecting line L₁, the distance between the first feature point O and the second feature point C may be from 7.5 mm to 10 mm, or the distance between the first feature point O and the second feature point C may be set to be greater than or equal to 5 mm and less than 7.5 mm. For example, the distance between the first feature point O and the second feature point C may be set to 5 mm, 6 mm, 7 mm, or other actual values greater than or equal to 5 mm and less than 7.5 mm. As another example, the distance between the first feature point O and the second feature point C may be set to 7.5 mm, 7.9 mm, 10 mm, or other actual values within the range of 7.5 mm to 10 mm.

A connecting line between the first feature point O and the second feature point C is defined as a first connecting line. In some embodiments, when the sound-generating portion 11 and the abutment portion 12 are in the non-contact structure shown in FIG. 4, an included angle (i.e., ∠COO₂) between the first connecting line OC and the shortest connecting line O₁O₂ may be from 50° to 70°. By designing the included angle between the first connecting line OC and the shortest connecting line O₁O₂, a position of the second feature point C relative to the first feature point O may be adjusted, thereby adjusting a shape of the ear hook 13, so that the ear hook 13 may adapt to more different ear sizes, avoid interference between the ear hook 13 and the ear, and ensure the wearing comfort and the clamping effect of the earphone 10. In some embodiments, if the included angle between the first connecting line OC and the shortest connecting line O₁O₂ is too large, it indicates that the deviation of the second feature point C from the first feature point O is too small, and with the second feature point C as a boundary, a portion of the ear hook 13 near the sound-generating portion 11 is too small. In the wearing state, the portion of the ear hook 13 near the sound-generating portion 11 may interfere with a portion of the ear on the front side of the auricle. If the included angle between the first connecting line OC and the shortest connecting line O₁O₂ is too small, it indicates that the deviation of the second feature point C from the first feature point O is too large, and with the second feature point C as a boundary, a portion of the ear hook 13 near the abutment portion 12 is too small. In the wearing state, the portion of the ear hook 13 near the abutment portion 12 may interfere with a portion of the ear on the rear side of the auricle.

To further reduce the possibility of interference between the ear hook 13 and the front side of the auricle, in some embodiments, when the sound-generating portion 11 and the abutment portion 12 have the non-contact structure shown in FIG. 4, the included angle (i.e., ∠COO₂) between the first connecting line OC and the shortest connecting line O₁O₂ may be from 50° to 65°. In some embodiments, to further avoid interference between the ear hook 13 and the rear side of the auricle, the included angle (i.e., ∠COO₂) between the first connecting line OC and the shortest connecting line O₁O₂ may be from 52° to 60°. Merely by way of example, the included angle between the first connecting line OC and the shortest connecting line O₁O₂ (i.e., ∠COO₂) may be 58°.

Correspondingly, when the sound-generating portion 11 and the abutment portion 12 are in the contact structure as shown in FIG. 6, an included angle (e.g., an angle α as shown in FIG. 6) between the first connecting line OC and the reference connecting line L₁ may be from 45° to 60°. Merely by way of example, the included angle (e.g., the angle α as shown in FIG. 6) between the first connecting line OC and the reference connecting line L₁ may be 55°. In some embodiments, when the sound-generating portion 11 and the abutment portion 12 are in the contact structure as shown in FIG. 6, the included angle (e.g., the angle α as shown in FIG. 6) between the first connecting line OC and the reference connecting line L₁ may be set to be greater than 60° and less than or equal to 70°. For example, the included angle (e.g., the angle α as shown in FIG. 6) between the first connecting line OC and the reference connecting line L₁ may be set to actual values greater than 60° and less than or equal to 70°, such as 61°, 64°, 65°, or 70°.

In some embodiments, when the abutment portion 12 and the sound-generating portion 11 have a structure such that the first projection 11′ and the second projection 12′ have an overlapping region, the included angle (e.g., the angle α as shown in FIG. 6) between the first connecting line OC and the reference connecting line L₁ may be from 45° to 60°, or greater than 60° and less than or equal to 70°. For example, in some embodiments, the included angle (e.g., the angle α as shown in FIG. 6) between the first connecting line OC and the reference connecting line L₁ may be set to actual values greater than 60° and less than or equal to 70°, such as 61°, 64°, 65°, or 70°. As another example, in some embodiments, the included angle (e.g., the angle α as shown in FIG. 6) between the first connecting line OC and the reference connecting line L₁ may be actual values within a range of 45° to 60°, such as 45°, 55°, or 60°.

In some embodiments, the second feature point C is a protruding point of the ear hook 13. Stress at the second feature point C of the ear hook 13 is relatively high. To avoid excessive stress concentration on the ear hook 13 and to improve a service life of the ear hook 13, a protrusion degree of the third projection 13′ near the second feature point C may not be excessively large. However, if the protrusion degree of the third projection 13′ near the second feature point C is excessively small, an overall structure and size of the earphone 10 may be affected, which may cause the ear hook 13 to interfere with the user's ear and affect wearing stability of the earphone 10.

In some embodiments, to characterize the protrusion degree of the ear hook 13 near the second feature point C, on the inner contour curve of the third projection 13′, with the second feature point C as a center, two arc segments with equal arc lengths (e.g., an arc CT₁ and an arc CT₂) may be determined on two sides of the second feature point C, respectively. A connecting line between two ends of the two arc segments (e.g., the arc CT₁ and the arc CT₂) away from the second feature point C is a connecting line T₁T₂. An arc segment corresponding to the connecting line T₁T₂ is an arc T₁T₂. An arc-chord ratio between an arc length of the arc T₁T₂ and a length of the connecting line T₁T₂ represents a bending degree of the corresponding arc T₁T₂, thereby representing the protrusion degree of the inner contour curve corresponding to the arc T₁T₂.

In some embodiments, to accurately characterize the protrusion degree of the ear hook 13 near the second feature point C, the point T₁ and the point T₂ should not be too close to or too far from the second feature point C. In some embodiments, when the sound-generating portion 11 and the abutment portion 12 have the non-contact structure as shown in FIG. 4 or the contact structure as shown in FIG. 6, an arc length of the arc CT₁ and an arc length of the arc CT₂ may be from 2.5 mm to 3.5 mm. In some embodiments, to further improve accuracy of characterizing the protrusion degree of the ear hook 13 near the second feature point C, a preset arc length range may be from 2.7 mm to 3.2 mm.

In some embodiments, when the sound-generating portion 11 and the abutment portion 12 have the non-contact structure as shown in FIG. 4, to avoid excessive stress concentration on the ear hook 13 and to ensure the wearing stability of the earphone 10, the arc-chord ratio between the arc length of the arc T₁T₂ and the length of the connecting line T₁T₂ may be from 1.00 to 1.10. In some embodiments, to further avoid excessive stress concentration on the ear hook 13 and to extend the service life of the ear hook 13, the arc-chord ratio between the arc length of the arc T₁T₂ and the length of the connecting line T₁T₂ may be 1.01 to 1.07. Merely by way of example, the arc-chord ratio between the arc length of the arc T₁T₂ and the length of the connecting line T₁T₂ may be 1.04.

In some embodiments, when the sound-generating portion 11 and the abutment portion 12 have the contact structure as shown in FIG. 6, the arc-chord ratio between the arc length of the arc T₁T₂ and the length of the connecting line T₁T₂ may be from 1.03 to 1.12. Merely by way of example, the arc-chord ratio between the arc length of the arc T₁T₂ and the length of the connecting line T₁T₂ may be 1.06.

Referring to FIG. 4 and FIG. 6, in some embodiments, in a vertical direction of the first connecting line OC, a portion of the outer contour of the earphone 10 close to the first projection 11′ has a first tangent line l₂ parallel to the first connecting line OC, and a portion of the outer contour of the earphone 10 close to the second projection 12′ has a second tangent line l₃ parallel to the first connecting line OC. In some embodiments, a portion of the earphone 10 between the first connecting line OC and the first tangent line l₂ corresponds to a change of the ear from the helix to the concha cavity, and a portion of the earphone 10 between the first connecting line OC and the second tangent line l₃ may correspond to a change of the ear from the helix to the back of the auricle.

If a distance d₁ between the first connecting line OC and the first tangent line l₂ is too small, the ear hook 13 may interfere with the front side of the auricle. If the distance d₁ between the first connecting line OC and the first tangent line l₂ is too large, the sound-generating portion 11 may interfere with the tragus. In some embodiments, when the sound-generating portion 11 and the abutment portion 12 have the contact structure as shown in FIG. 6, to minimize interference between the earphone 10 and the ear of the user, the distance d₁ between the first connecting line OC and the first tangent line l₂ may be from 12 mm to 15.5 mm. In some embodiments, to further reduce a possibility of interference between the sound-generating portion 11 and the tragus, the distance d₁ between the first connecting line OC and the first tangent line l₂ may be from 13 mm to 15 mm. In some embodiments, to further reduce the possibility of interference between the ear hook 13 and the front side of the auricle, the distance d₁ between the first connecting line OC and the first tangent line l₂ may be from 13.5 mm to 14.6 mm. Merely by way of example, the distance d₁ between the first connecting line OC and the first tangent line l₂ may be 13.6 mm.

In some embodiments, when the sound-generating portion 11 and the abutment portion 12 have the non-contact structure as shown in FIG. 4, the distance d₁ between the first connecting line OC and the first tangent line l₂ may be from 13 mm to 16 mm. Merely by way of example, the distance d₁ between the first connecting line OC and the first tangent line l₂ may be 14.4 mm.

If a distance d₂ between the first connecting line OC and the second tangent line l₃ is too small, the ear hook 13 may interfere with the back of the auricle. If the distance d₂ between the first connecting line OC and the second tangent line l₃ is too large, the abutment portion 12 may interfere with head skin at the back of the auricle of the user, and the abutment portion 12 may excessively compress the head skin at the back of the auricle of the user.

In some embodiments, when the sound-generating portion 11 and the abutment portion 12 have the contact structure as shown in FIG. 6, to minimize interference between the earphone 10 and the ear of the user and the head skin near the ear, the distance d₂ between the first connecting line OC and the second tangent line l₃ may be from 10.5 mm to 13 mm. In some embodiments, to further avoid interference between the ear hook 13 and the back of the auricle, the distance d₂ between the first connecting line OC and the second tangent line l₃ may be from 11 mm to 12.5 mm. In some embodiments, to further avoid interference between the abutment portion 12 and the head skin at the back of the auricle of the user, the distance d₂ between the first connecting line OC and the second tangent line l₃ may be from 11.5 mm to 12 mm. Merely by way of example, the distance d₂ between the first connecting line OC and the second tangent line l₃ may be 11.6 mm.

In some embodiments, when the sound-generating portion 11 and the abutment portion 12 have the non-contact structure as shown in FIG. 4, the distance d₂ between the first connecting line OC and the second tangent line l₃ may be from 10 mm to 12.5 mm. Merely by way of example, the distance d₂ between the first connecting line OC and the second tangent line l₃ may be 11.5 mm.

The second projection 12′ has a centroid F. The centroid F of the second projection 12′ is defined as a third feature point. In some embodiments, when the sound-generating portion 11 and the abutment portion 12 have the non-contact structure as shown in FIG. 4, a straight line where the shortest connecting line O₁O₂ lies has two intersection points with the second projection 12′. The third feature point F may be a midpoint of the two intersection points. In some embodiments, when the sound-generating portion 11 and the abutment portion 12 have the contact structure as shown in FIG. 6, a parallel line parallel to the reference connecting line L₁ is drawn through the first feature point O. The parallel line has two intersection points with the second projection 12′. The third feature point F may be a midpoint of the two intersection points. In some embodiments, the centroid of the second projection 12′ refers to a centroid of a projection of an internal cavity of the abutment portion 12 on the first symmetry plane S₁, i.e., a centroid of the inner contour of the second projection 12′ as shown in FIG. 4 or FIG. 6.

In some embodiments, when the sound-generating portion 11 and the abutment portion 12 have the non-contact structure as shown in FIG. 4, in the direction of the shortest connecting line O₁O₂, the second feature point C is farther away from the first feature point O than the third feature point F. This arrangement ensures that asymmetry of the ear hook 13 allows the ear hook 13 to correspond to changes from the helix to the back of the auricle and to the concha cavity, avoids interference between the ear hook 13 and the front side and the back of the auricle, and improves wearing comfort of the earphone 10.

Correspondingly, when the sound-generating portion 11 and the abutment portion 12 have the contact structure as shown in FIG. 6, in a direction defined by the reference connecting line L₁, the second feature point C is farther away from the first feature point O than the third feature point F.

In some embodiments, when the abutment portion 12 and the sound-generating portion 11 have a structure such that the first projection 11′ and the second projection 12′ have an overlapping region, in the direction defined by the reference connecting line L₁, the second feature point C is farther away from the first feature point O than the third feature point F.

In some embodiments, if an included angle (i.e., ∠COF) between a connecting line OF of the third feature point F and the first feature point O and the first connecting line OC is too large, it indicates that the deviation of the second feature point C from the first feature point O is too small, and that with the second feature point C as a boundary point, the portion of the ear hook 13 close to the sound-generating portion 11 is too small. In the wearing state, the portion of the ear hook 13 close to the sound-generating portion 11 may interfere with a portion of the front side of the auricle. If the included angle between the connecting line OF and the first connecting line OC is too small, it indicates that the deviation of the second feature point C from the first feature point O is too large, and that with the second feature point C as a boundary point, the portion of the ear hook 13 close to the abutment portion 12 is too small. In the wearing state, the portion of the ear hook 13 close to the abutment portion 12 may interfere with a portion of the back of the auricle.

In some embodiments, when the sound-generating portion 11 and the abutment portion 12 have the contact structure as shown in FIG. 6, to avoid interference between the ear hook 13 and the ear of the user, the included angle (i.e., ∠COF) between the connecting line OF and the first connecting line OC may be from 45° to 65°. In some embodiments, to further reduce the possibility of interference between the ear hook 13 and the front side of the auricle, the included angle between the connecting line OF and the first connecting line OC may be from 50° to 60°. In some embodiments, to further reduce a possibility of interference between the ear hook 13 and the back of the auricle, the included angle between the connecting line OF and the first connecting line OC may be from 52° to 55°. Merely by way of example, the included angle between the connecting line OF and the first connecting line OC may be 53°.

In some embodiments, when the abutment portion 12 and the sound-generating portion 11 are configured in a structure that enables the first projection 11′ and the second projection 12′ have an overlapping region, the included angle (i.e., ∠COF) between the connecting line OF and the first connecting line OC may be from 45° to 65° to avoid interference between the ear hook 13 and the ear of the user. In some embodiments, to further reduce the possibility of interference between the ear hook 13 and the front side of the auricle, the included angle between the connecting line OF and the first connecting line OC may be from 50° to 60°. In some embodiments, to further reduce the possibility of interference between the ear hook 13 and the back of the auricle, the included angle between the connecting line OF and the first connecting line OC may be from 52° to 55°. Merely by way of example, the included angle between the connecting line OF and the first connecting line OC may be 53°.

In some embodiments, when the sound-generating portion 11 and the abutment portion 12 have the non-contact structure as shown in FIG. 4, the included angle between the connecting line OF and the first connecting line OC may be from 42° to 62°. Merely by way of example, the included angle (i.e., ∠COF) between the connecting line OF and the first connecting line OC may be 50°.

In some embodiments, a first auxiliary line L₄ is drawn through the second feature point C toward a side biased toward the first projection 11′. A first included angle between the first auxiliary line L₄ and the first connecting line (i.e., the connecting line OC) has a first preset value range. An intersection point E between an inner contour curve of the third projection 13′ and the first auxiliary line L₄ may be defined as a fourth feature point. A connecting line CE between the fourth feature point E and the second feature point C is a second connecting line. The second connecting line (i.e., the connecting line CE) is collinear with the first auxiliary line L₄. In some embodiments, the fourth feature point E may serve as a boundary point between the inner contour curve of the third projection 13′ and the inner contour of the first projection 11′. A portion of the ear hook 13 corresponding to the second connecting line CE (e.g., a portion corresponding to an arc segment CE) is disposed on a side of the second connecting line CE away from the abutment portion 12 to avoid interference between the ear hook 12 and the antihelix and the helix.

In some embodiments, if the first included angle (i.e., ∠OCE) between the second connecting line CE and the first connecting line OC is too small, an inner contour of the portion of the ear hook 13 corresponding to the second connecting line CE may interfere with and squeeze a portion of the ear of the user from the helix to the concha cavity. If the first included angle between the second connecting line CE and the first connecting line OC is too large, the size of the ear hook 13 may become too large, causing the sound-generating portion 11 to interfere with the tragus of the user or block the ear canal opening of the user.

In some embodiments, when the sound-generating portion 11 and the abutment portion 12 have the non-contact structure as shown in FIG. 4, the first preset value range may be from 30° to 40° to avoid the sound-generating portion 11 blocking the ear canal opening of the user and to avoid the sound-generating portion 11 interfering with the tragus or the antihelix and the helix. That is to say, the first included angle between the second connecting line CE and the first connecting line OC may be from 30° to 40°. In some embodiments, to further prevent the sound-generating portion 11 from interfering with the tragus or blocking the ear canal opening, the first included angle between the second connecting line CE and the first connecting line OC may be from 32° to 37°. In some embodiments, to further prevent the sound-generating portion 11 from interfering with the antihelix and the helix, the first included angle between the second connecting line CE and the first connecting line OC may be 36°.

In some embodiments, when the sound-generating portion 11 and the abutment portion 12 have the contact structure as shown in FIG. 6, the included angle between the second connecting line CE and the first connecting line may be from 27° to 37°. Merely by way of example, the included angle between the second connecting line CE and the first connecting line may be 33°. In some embodiments, when the sound-generating portion 11 and the abutment portion 12 have the contact structure as shown in FIG. 6, the included angle between the second connecting line CE and the first connecting line may be greater than 37° and less than or equal to 50°. For example, the included angle between the second connecting line CE and the first connecting line may be an actual value greater than 37° and less than or equal to 50°, such as 39°, 40°, 45°, 50°, etc.

In some embodiments, when the abutment portion 12 and the sound-generating portion 11 are configured as a structure such that the first projection 11′ and the second projection 12′ have an overlapping region, the included angle between the second connecting line CE and the first connecting line may be from 27° to 37°, or greater than 37° and less than or equal to 50°. For example, the included angle between the second connecting line CE and the first connecting line may be an actual value greater than 37° and less than or equal to 50°, such as 39°, 40°, 45°, 50°, etc. As another example, the included angle between the second connecting line CE and the first connecting line may be an actual value within the range of 27° to 37°, such as 27°, 28°, 33°, 37°, etc.

In some embodiments, if a distance between the fourth feature point E and the second feature point C (i.e., a length of the second connecting line CE) is too large, the size of the ear hook 13 may become too large, causing the sound-generating portion 11 to interfere with the tragus of the user or to be too close to or even block the ear canal opening. If the distance between the fourth feature point E and the second feature point C is too small, the inner contour of the portion of the ear hook 13 corresponding to the second connecting line CE may interfere with and squeeze the portion of the ear of the user from the helix to the concha cavity.

In some embodiments, when the sound-generating portion 11 and the abutment portion 12 have the non-contact structure as shown in FIG. 4, the length of the second connecting line CE may be from 16 mm to 22 mm to avoid the sound-generating portion 11 blocking the ear canal opening of the user and to avoid the sound-generating portion 11 interfering with the tragus or the antihelix and the helix. In some embodiments, to further avoid the sound-generating portion 11 interfering with the tragus or blocking the ear canal opening, the length of the second connecting line CE may be from 16.5 mm to 21 mm. In some embodiments, to further avoid the sound-generating portion 11 interfering with the antihelix and the helix, the length of the second connecting line CE may be from 17 mm to 20 mm. Merely by way of example, the length of the second connecting line CE may be 17.8 mm.

In some embodiments, when the sound-generating portion 11 and the abutment portion 12 have the contact structure as shown in FIG. 6, the length of the second connecting line CE may be from 15.5 mm to 21.5 mm. Merely by way of example, the length of the second connecting line CE may be 17.2 mm. In some embodiments, when the sound-generating portion 11 and the abutment portion 12 have the contact structure as shown in FIG. 6, the length of the second connecting line CE may be greater than or equal to 12 mm and less than 15.5 mm. For example, the length of the second connecting line CE may be set to an actual value greater than or equal to 12 mm and less than 15.5 mm, such as 12 mm, 13 mm, 14 mm, 14.77 mm, 15 mm, etc.

In some embodiments, when the abutment portion 12 and the sound-generating portion 11 are configured as a structure such that the first projection 11′ and the second projection 12′ have an overlapping region, the length of the second connecting line CE may be from 15.5 mm to 21.5 mm, or greater than or equal to 12 mm and less than 15.5 mm. For example, in some embodiments, the length of the second connecting line CE may be set to an actual value greater than or equal to 12 mm and less than 15.5 mm, such as 12 mm, 13 mm, 14 mm, 14.77 mm, 15 mm, etc. As another example, in some embodiments, the length of the second connecting line CE may be set to an actual value within the range of 15.5 mm to 21.5 mm, such as 15.5 mm, 17.2 mm, 21.5 mm, etc.

In some embodiments, a portion (i.e., the arc segment CE) of the inner contour curve of the third projection 13′ corresponding to the second connecting line CE has a first arc length. A ratio of the first arc length to the length of the second connecting line CE may be defined as a first arc-chord ratio. The first arc-chord ratio may reflect a degree of flatness of the arc segment CE corresponding to the second connecting line CE. The larger the first arc-chord ratio, the greater a protrusion degree of the arc segment CE corresponding to the second connecting line CE and the larger an area of a region within the arc segment CE, making a corresponding portion of the ear hook 13 less likely to interfere with a portion of the ear from the helix to the concha cavity. The smaller first arc-chord ratio is, the flatter the arc segment CE corresponding to the second connecting line CE and the smaller the area of the region within the arc CE, and thus the corresponding portion of the ear hook 13 may interfere with the portion (e.g., the helix and the antihelix) of the ear from the helix to the concha cavity. In some embodiments, when the sound-generating portion 11 and the abutment portion 12 have the non-contact structure as shown in FIG. 4, the first arc-chord ratio may be greater than 1.05 to avoid interference between the ear hook 13 and the helix and the antihelix.

If the first arc-chord ratio is too large, the size of the ear hook 13 may become too large, leading to an oversized overall size of the earphone 10, which affects a wearing effect and reduces portability. In some embodiments, when the sound-generating portion 11 and the abutment portion 12 have the non-contact structure as shown in FIG. 4, the first arc-chord ratio may be less than 1.20 to make the overall size of the earphone 10 suitable. In some embodiments, to further reduce the overall size of the earphone 10, the first arc-chord ratio may be from 1.08 to 1.17. In some embodiments, to further avoid interference between the ear hook 13 and the ear, the first arc-chord ratio may be from 1.10 to 1.15. Merely by way of example, the first arc-chord ratio may be 1.13.

In some embodiments, when the sound-generating portion 11 and the abutment portion 12 have the contact structure as shown in FIG. 6, the first arc-chord ratio may be from 1.10 to 1.25. Merely by way of example, the first arc-chord ratio may be 1.14. In some embodiments, when the sound-generating portion 11 and the abutment portion 12 have the contact structure as shown in FIG. 6, the first arc-chord ratio may be set to be greater than or equal to 1.05 and less than 1.10 to make the overall size of the earphone 10 suitable. For example, in some embodiments, the first arc-chord ratio may be set to an actual value greater than or equal to 1.05 and less than 1.10, such as 1.05, 1.08, 1.09, etc.

In some embodiments, when the abutment portion 12 and the sound-generating portion 11 are configured as a structure such that the first projection 11′ and the second projection 12′ have an overlapping region, the first arc-chord ratio may be from 1.10 to 1.25, or greater than or equal to 1.05 and less than 1.10 to make the overall size of the earphone 10 suitable. For example, in some embodiments, the first arc-chord ratio may be an actual value within the range of 1.10 to 1.25, such as 1.10, 1.14, 1.25, etc. As another example, in some embodiments, the first arc-chord ratio may be set to an actual value greater than or equal to 1.05 and less than 1.10, such as 1.05, 1.08, 1.09, etc.

In some embodiments, the inner contour curve (i.e., the arc segment CE) corresponding to the second connecting line CE may be defined as a first arc segment. A distance from the first arc segment to the second connecting line CE is minimum (zero) at two endpoints (the point C and the point E), and the distance from the first arc segment to the second connecting line CE is maximum at a vertex of the arc segment CE. The maximum distance may reflect the degree of flatness of the arc segment CE. If the maximum distance is too large, the degree of protrusion of the arc segment CE is too large, the size of the ear hook 13 is too large, the overall size of the earphone 10 is too large, the wearing effect is affected, and portability is reduced.

In some embodiments, when the sound-generating portion 11 and the abutment portion 12 have the non-contact structure shown in FIG. 4, to avoid the first arc segment of the ear hook 13 from protruding too much, the distance from the second connecting line CE to the first arc segment (i.e., the arc segment CE) may be not greater than 3.4 mm. In some embodiments, to further avoid the size of the ear hook 13 from being too large to affect the wearing effect of the earphone 10, the distance from the second connecting line CE to the first arc segment (i.e., the arc segment CE) may be not greater than 3.0 mm. In some embodiments, to further avoid the size of the ear hook 13 from being too large, the distance from the second connecting line CE to the first arc segment (i.e., the arc segment CE) may be not greater than 2.8 mm.

In some embodiments, when the sound-generating portion 11 and the abutment portion 12 have the contact structure shown in FIG. 6, the distance from the second connecting line CE to the first arc segment (i.e., the arc segment CE) may be not greater than 3.2 mm. In some embodiments, when the sound-generating portion 11 and the abutment portion 12 are the contact structure shown in FIG. 6, the distance from the second connecting line CE to the first arc segment (i.e., the arc segment CE) may be not greater than 7.5 mm. For example, the distance from the second connecting line CE to the first arc segment (i.e., the arc segment CE) may be an actual value not greater than 7.5 mm, such as 7.5 mm, 3.2 mm, 3.6 mm, or 5.2 mm.

In some embodiments, when the abutment portion 12 and the sound-generating portion 11 have a structure that causes the first projection 11′ and the second projection 12′ to have an overlapping region, the distance from the second connecting line CE to the first arc segment (i.e., the arc segment CE) may be not greater than 3.2 mm, or the distance from the second connecting line CE to the first arc segment (i.e., the arc segment CE) may be not greater than 7.5 mm. For example, in some embodiments, the distance from the second connecting line CE to the first arc segment (i.e., the arc segment CE) may be an actual value not greater than 7.5 mm, such as 7.5 mm, 3.2 mm, 3.6 mm, or 5.2 mm.

In some embodiments, a second auxiliary line L₅ is drawn through the second feature point C toward a side biased toward the second projection 12′. A second included angle between the second auxiliary line L₅ and the first connecting line OC has a second preset value range. An intersection point H between the second auxiliary line L₅ and a curve segment of the inner contour curve of the third projection 13′ that is connected to the second projection 12′ may be defined as a fifth feature point. A connecting line CH between the fifth feature point H and the second feature point C is defined as a fourth connecting line. The fourth connecting line CH is collinear with the second auxiliary line L₅. In some embodiments, the fifth feature point H may serve as a boundary point between the inner contour curve of the second projection 12′ and the inner contour curve of the third projection 13′.

In some embodiments, if the second included angle (i.e., ∠OCH) between the fourth connecting line CH and the first connecting line OC is too small, the abutment portion 12 may excessively squeeze the back of the auricle of the user. If the second included angle between the fourth connecting line CH and the first connecting line OC is too large, the size of the ear hook 13 may be too large, causing the abutment portion 12 to interfere with skin tissue of the head at the back of the auricle of the user.

In some embodiments, when the sound-generating portion 11 and the abutment portion 12 have the non-contact structure shown in FIG. 4, to avoid the abutment portion 12 from excessively squeezing the ear and to avoid the abutment portion 12 from interfering with the head skin of the user, the second included angle between the fourth connecting line CH and the first connecting line OC may be from 35° to 50°. In some embodiments, to further avoid the abutment portion 12 from excessively squeezing the ear, the second included angle between the fourth connecting line CH and the first connecting line OC may be from 36° to 43°. In some embodiments, to further avoid the abutment portion 12 from interfering with the head skin of the user, the second included angle between the fourth connecting line CH and the first connecting line OC may be from 38° to 42°. For example, the second included angle between the fourth connecting line CH and the first connecting line OC may be 41°.

In some embodiments, when the sound-generating portion 11 and the abutment portion 12 have the contact structure shown in FIG. 6, the included angle between the fourth connecting line CH and the first connecting line OC may be from 34° to 49°. For example, the included angle between the fourth connecting line CH and the first connecting line OC may be 40°. In some embodiments, when the sound-generating portion 11 and the abutment portion 12 have the contact structure shown in FIG. 6, the included angle between the fourth connecting line CH and the first connecting line OC may be set to be greater than or equal to 20° and less than 34°. For example, in some embodiments, the included angle between the fourth connecting line CH and the first connecting line OC may be an actual value greater than or equal to 20° and less than 34°, such as 20°, 25°, 27°, or 33°.

In some embodiments, if a distance between the fifth feature point H and the second feature point C (i.e., a length of the fourth connecting line CH) is too large, the size of the ear hook 13 may be too large, the overall size of the earphone 10 may be too large, the wearing effect may be affected, and the portability may be reduced. If the distance between the fifth feature point H and the second feature point C is too small, the ear hook 13 may interfere with the rear side of the auricle. Furthermore, the abutment portion 12 located at the back of the auricle and the sound-generating portion 11 located in the concha cavity may be misaligned, thereby affecting clamping firmness between the abutment portion 12 and the sound-generating portion 11 and affecting the wearing stability of the earphone 10.

In some embodiments, when the sound-generating portion 11 and the abutment portion 12 have the non-contact structure shown in FIG. 4, to avoid the size of the ear hook 13 from affecting the wearing effect, avoid the ear hook 13 from interfering with the rear side of the auricle, avoid misalignment between the abutment portion 12 and the sound-generating portion 11, and improve the wearing stability of the earphone 10, the length of the fourth connecting line CH may be from 7 mm to 9 mm. In some embodiments, to further avoid the size of the ear hook 13 from being too large, the length of the fourth connecting line CH may be from 7.2 mm to 8.6 mm. In some embodiments, to further improve the wearing stability and wearing comfort of the earphone 10, the length of the fourth connecting line CH may be from 7.4 mm to 8.2 mm. For example, the length of the fourth connecting line CH may be 7.6 mm.

In some embodiments, when the sound-generating portion 11 and the abutment portion 12 have the contact structure shown in FIG. 6, a length of the third connecting line CH may be from 7.2 mm to 9.2 mm. For example, the length of the fourth connecting line CH may be 7.8 mm.

In some embodiments, when the abutment portion 12 and the sound-generating portion 11 are configured as a structure that causes the first projection 11′ and the second projection 12′ to have an overlapping region, the length of the fourth connecting line CH may be from 7.2 mm to 9.2 mm. For example, the length of the fourth connecting line CH may be an actual value within the range of 7.2 mm to 9.2 mm, such as 7.2 mm, 7.8 mm, or 9.2 mm.

In some embodiments, a portion (i.e., an arc segment CH) of the inner contour curve of the third projection 13′ corresponding to the fourth connecting line CH has a third arc length. A ratio of the third arc length to the length of the fourth connecting line CH may be defined as a third arc-chord ratio. The third arc-chord ratio may reflect a degree of flatness of the arc segment CH corresponding to the fourth connecting line CH. The larger the third arc-chord ratio is, the greater a degree of protrusion of the arc segment CH corresponding to the fourth connecting line CH and the larger an area of a region within the arc segment CH, thus a higher likelihood that the abutment portion 12 and the ear hook 13 abut against the head skin at the back of the auricle. The smaller the third arc-chord ratio is, the flatter the arc segment CH corresponding to the fourth connecting line CH and the smaller the area of the region within the arc segment CH, thus a higher likelihood that a corresponding portion of the ear hook 13 may interfere with a portion (e.g., a most outer point of the helix) of the ear from the helix to the back of the auricle.

In some embodiments, when the sound-generating portion 11 and the abutment portion 12 have the non-contact structure shown in FIG. 4, to avoid the ear hook 13 from interfering with the ear and to avoid the abutment portion 12 and the ear hook 13 from squeezing the head skin at the back of the auricle of the user as much as possible, the third arc-chord ratio may be from 1.10 to 1.23. In some embodiments, to further avoid the ear hook 13 from interfering with the ear, the third arc-chord ratio may be 1.13 to 1.20. In some embodiments, to further avoid the abutment portion 12 from squeezing the head skin at the back of the auricle of the user, the third arc-chord ratio may be from 1.15 to 1.19. For example, the third arc-chord ratio may be 1.18.

Furthermore, by setting a range for the third arc-chord ratio, the arc segment CH can have a relatively high degree of protrusion, thereby distinguishing it from the relatively flat arc segment CE segment. That is to say, a curve on a side of the ear hook 13 that is connected to the sound-generating portion 11 is relatively flat, and a curve on another side of the ear hook 13 that is connected to the abutment portion 12 is relatively protruding, thereby facilitating the user in identifying a wearing direction and avoiding incorrect wearing.

In some embodiments, when the sound-generating portion 11 and the abutment portion 12 have the contact structure shown in FIG. 6, the third arc-chord ratio may be from 1.11 to 1.24. For example, the third arc-chord ratio may be 1.17. In some embodiments, when the sound-generating portion 11 and the abutment portion 12 have the contact structure shown in FIG. 6, the third arc-chord ratio may be set to be greater than 1.24 and less than or equal to 1.4. For example, in some embodiments, the third arc-chord ratio may be an actual value greater than 1.24 and less than or equal to 1.4, such as 1.25, 1.29, 1.3, or 1.4.

Referring to FIG. 4, in some embodiments, when the sound-generating portion 11 and the abutment portion 12 have the non-contact structure shown in FIG. 4, an extension line of the shortest connecting line O₁O₂ may be drawn. The extension line intersects the first projection 11′ at points O₁ and G, and point G is defined as a sixth feature point. In some embodiments, a distance between the first feature point O and the sixth feature point G (i.e., a length of a connecting line OG) may reflect a size of the sound-generating portion 13. If the distance between the first feature point O and the sixth feature point G is too large, the size of the sound-generating portion 11 is too large, and the sound-generating portion 11 easily interferes with the tragus and squeezes the tragus. If the distance between the first feature point O and the sixth feature point G is too small, the size of the sound-generating portion 11 is too small, a pressure in the concha cavity in the wearing state is too high, and a sound production efficiency of the sound-generating portion 11 is reduced.

In some embodiments, when the sound-generating portion 11 and the abutment portion 12 have the non-contact structure as shown in FIG. 4, the distance between the first feature point O and the sixth feature point G may be from 12 mm to 15 mm to avoid the sound-generating portion 11 from pressing the tragus, make the size of the sound-generating portion 11 suitable, and improve the sound production efficiency. In some embodiments, to further avoid the sound-generating portion 11 from pressing the tragus, the distance between the first feature point O and the sixth feature point G may be from 12.5 mm to 14 mm. In some embodiments, to further make the size of the sound-generating portion 11 suitable, the distance between the first feature point O and the sixth feature point G may be from 13.5 mm.

In some embodiments, when the sound-generating portion 11 and the abutment portion 12 have the contact structure as shown in FIG. 6, a parallel line parallel to the connecting line AB (i.e., the straight line L₁) may be drawn through the point O. The parallel line intersects the first projection 11′ at the point O and the point G, thereby determining a position of the sixth feature point G. In some embodiments, when the sound-generating portion 11 and the abutment portion 12 have the contact structure as shown in FIG. 6, the distance between the first feature point O and the sixth feature point G may be from 10.5 mm to 15.5 mm. Merely by way of example, the distance between the first feature point O and the sixth feature point G may be 13.0 mm. In some embodiments, when the sound-generating portion 11 and the abutment portion 12 have the contact structure as shown in FIG. 6, the distance between the first feature point O and the sixth feature point G may be set to be greater than 15.5 mm and less than or equal to 17 mm. For example, in some embodiments, the distance between the first feature point O and the sixth feature point G may be set to an actual value greater than 15.5 mm and less than or equal to 17 mm, such as 16 mm, 16.5 mm, or 17 mm.

In some embodiments, when the abutment portion 12 and the sound-generating portion 11 are configured as a structure that causes the first projection 11′ and the second projection 12′ to have an overlapping region, a parallel line parallel to the connecting line AB (i.e., the straight line L₁) may be drawn through the point O. The parallel line intersects the first projection 11′ at the point O and the point G, thereby determining the position of the sixth feature point G. In some embodiments, when the abutment portion 12 and the sound-generating portion 11 are configured as the structure that causes the first projection 11′ and the second projection 12′ to have the overlapping region, the distance between the first feature point O and the sixth feature point G may be from 10.5 mm to 15.5 mm. Merely by way of example, the distance between the first feature point O and the sixth feature point G may be an actual value within the range of 10.5 mm to 15.5 mm, such as 10.5 mm, 13.0 mm, 14.2 mm, or 15.5 mm. In some embodiments, when the abutment portion 12 and the sound-generating portion 11 are configured as the structure that causes the first projection 11′ and the second projection 12′ to have the overlapping region, the distance between the first feature point O and the sixth feature point G may also be set to be greater than 15.5 mm and less than or equal to 17 mm. For example, in some embodiments, the distance between the first feature point O and the sixth feature point G may also be set to 16 mm, 16.5 mm, 17 mm, or other actual values greater than 15.5 mm and less than or equal to 17 mm.

Referring to FIG. 2, FIG. 3A, FIG. 3B, FIG. 4, and FIG. 6, in some embodiments, a pressure relief hole (not shown in the drawings) may be provided on the housing of the sound-generating portion 11. The sound outlet hole 111 and the pressure relief hole are acoustically coupled to acoustic cavities on two sides of a diaphragm of the sound-generating assembly, respectively, to respectively guide out sound from the corresponding acoustic cavities. In some embodiments, a connecting line between a centroid of the pressure relief hole and a centroid J of the sound outlet hole 111 may point to the ear canal opening of the user to improve acoustic directivity of the sound-generating assembly. Optionally, the pressure relief hole may be provided near a connection position between the housing of the sound-generating portion 11 and the ear hook 13. Correspondingly, a position of a projection of the pressure relief hole on the first symmetry plane S₁ is near a position where the inner contour of the first projection 11′ connects to the inner contour of the third projection 13′. That is to say, the position of the projection of the pressure relief hole on the first symmetry plane S₁ is on a region of the inner contour curve of the first projection 11′ or the inner contour curve of the third projection 13′ near the fifth feature point E.

On the inner contour curve of the third projection 13′ and the inner contour of the first projection 11′, a second arc segment (e.g., an arc segment EP₁) and a third arc segment (e.g., an arc segment EP₂) are determined with the fourth feature point E as a center, on two sides of the point E, respectively. An arc length of the second arc segment (i.e., the arc segment EP₁) and an arc length of the third arc segment (i.e., the arc segment EP₂) are both within a preset arc length range. A connecting line (i.e., a connecting line P₁P₂) between an end (i.e., a point P₁) of the second arc segment (i.e., the arc segment EP₁) away from the fourth feature point E and an end (i.e., a point P₂) of the third arc segment (i.e., the arc segment EP₂) away from the fourth feature point E is defined as a third connecting line. In some embodiments, the projection of the pressure relief hole on the first symmetry plane S₁ may be provided on an arc segment (i.e., an arc segment P₁P₂) corresponding to the third connecting line P₁P₂. In some embodiments, the projection of the pressure relief hole on the first symmetry plane S₁ may be provided on a portion (e.g., an arc segment EP1 shown in FIG. 4 and FIG. 6) of the arc segment P₁P₂ located on a contour of the first projection 11′. In some embodiments, an outer contour of the projection of the pressure relief hole on the first symmetry plane S₁ has two endpoints. Taking FIG. 6 as an example, a point Q₁ and a point Q₂ shown in FIG. 6 are the aforementioned two endpoints. An opening between the point Q₁ and the point Q₂ is the outer contour of the projection of the pressure relief hole. In some embodiments, to make the arc segment P₁P₂ continuous, the point Q₁ and the point Q₂ may be connected, and a connecting line Q₁Q₂ may represent an arc segment Q₁Q₂.

The arc segment P₁P₂ has a second arc length. The second arc length is a sum of the arc length of the second arc segment (i.e., the arc segment EP₁) and the arc length of the third arc segment (i.e., the arc segment EP₂). To provide sufficient setting space for the pressure relief hole, the second arc length of the arc segment P₁P₂ should not be too small. To avoid the pressure relief hole from deviating in position and affecting directivity of the sound-generating portion 11, the second arc length of the arc segment P₁P₂ should not be too large. In some embodiments, when the sound-generating portion 11 and the abutment portion 12 have the non-contact structure as shown in FIG. 4 or the contact structure as shown in FIG. 6, the preset arc length range may be from 2.5 mm to 3.5 mm. In some embodiments, to further provide a suitable setting position for the pressure relief hole, the preset arc length range may be from 2.7 mm to 3.2 mm.

In some embodiments, when the abutment portion 12 and the sound-generating portion 11 are in a structure that causes the first projection 11′ and the second projection 12′ to have an overlapping region, the preset arc length range may be from 2.5 mm to 3.5 mm. In some embodiments, when the abutment portion 12 and the sound-generating portion 11 are in the structure that causes the first projection 11′ and the second projection 12′ to have the overlapping region, to further provide a suitable setting position for the pressure relief hole, the preset arc length range may be from 2.7 mm to 3.2 mm.

In some embodiments, a ratio of the second arc length of the arc segment P₁P₂ corresponding to the third connecting line P₁P₂ to a length of the third connecting line P₁P₂ is defined as a second arc-chord ratio. The larger the second arc-chord ratio is, the greater a curvature of the arc segment P₁P₂ and the higher a degree of concavity of an inner contour near a connection position between the sound-generating portion 11 and the ear hook 13 corresponding to the arc segment P₁P₂. The smaller the second arc-chord ratio is, the smaller the curvature of the arc segment P₁P₂ and the lower the degree of concavity of the inner contour near the connection position between the sound-generating portion 11 and the ear hook 13 corresponding to the arc segment P₁P₂.

In some embodiments, since the projection of the pressure relief hole on the first symmetry plane S₁ is located on the arc segment P₁P₂, to avoid the pressure relief hole from being blocked by the auricle in the wearing state, the curvature of the arc segment P₁P₂ should be greater than a certain threshold, which makes the inner contour near the connection position between the sound-generating portion 11 and the ear hook 13 corresponding to the arc segment P₁P₂ sufficiently concave, so that the pressure relief hole provided at the concave position is not blocked by the auricle.

In some embodiments, when the sound-generating portion 11 and the abutment portion 12 have the non-contact structure as shown in FIG. 4, to avoid the pressure relief hole from being blocked by the auricle, the second arc-chord ratio is greater than 1.26. In some embodiments, to avoid the connection position between the sound-generating portion 11 and the ear hook 13 from being too thin and affecting connection strength, the concave should not be too deep. The second arc-chord ratio may be less than 1.44, i.e., the second arc-chord ratio may be from 1.26 to 1.44. In some embodiments, to further ensure the concave has sufficient depth to avoid the pressure relief hole from being blocked by the auricle, the second arc-chord ratio may be from 1.29 to 1.40. In some embodiments, to further avoid the connection position between the sound-generating portion 11 and the ear hook 13 from being too thin and affecting the connection strength, the second arc-chord ratio may be from 1.33 to 1.38. Merely by way of example, the second arc-chord ratio may be 1.35.

In some embodiments, when the sound-generating portion 11 and the abutment portion 12 have the contact structure as shown in FIG. 6, a shape of the arc segment P₁P₂ may be the same as or similar to a shape in the non-contact structure as shown in FIG. 4, and the second arc-chord ratio may be from 1.26 to 1.44. Merely by way of example, the second arc-chord ratio may be 1.35.

In some embodiments, when the abutment portion 12 and the sound-generating portion 11 are in a structure that causes the first projection 11′ and the second projection 12′ to have an overlapping region, the shape of the arc segment P₁P₂ may be the same as or similar to the shape in the non-contact structure as shown in FIG. 4, and the second arc-chord ratio may be from 1.26 to 1.44. Merely by way of example, the second arc-chord ratio may be 1.26, 1.32, 1.35, 1.44, or other actual values within the range of 1.26 to 1.44.

In some embodiments, when the sound-generating portion 11 and the abutment portion 12 have the non-contact structure as shown in FIG. 4, an endpoint of the shortest connecting line O₁O₂ on the first projection 11′ is the point O₁, and an endpoint of the arc segment P₁P₂ close to the first projection 11′ is the point P1. In the wearing state, at least a portion (i.e., an arc segment O₁P₁) of the inner contour of the first projection 11′ between the point O₁ and the point P₁ abuts and fits against the concha cavity, thereby isolating the sound outlet hole 111 from the pressure relief hole to avoid acoustic short circuit (i.e., a sound from the sound outlet hole and a sound from the pressure relief hole interfering and canceling each other at the ear canal) and affecting a sound-generating effect of the sound-generating portion 11.

In some embodiments, when the sound-generating portion 11 and the abutment portion 12 have the contact structure as shown in FIG. 6, in the wearing state, at least a portion between the first feature point O and the point P1 (i.e., an arc segment OP₁) abuts and fits against the concha cavity, thereby isolating the sound outlet hole 111 from the pressure relief hole to avoid acoustic short circuit and affecting the sound-generating effect of the sound-generating portion 11.

In some embodiments, a point N on the first projection 11′ that is closest to the second feature point C may be defined as a seventh feature point. A connecting line CN between the second feature point C and the seventh feature point N is defined as a fifth connecting line. If a length of the fifth connecting line CN is too large, the sound-generating portion 11 may interfere with the tragus of the user. If the length of the fifth connecting line CN is too small, the ear hook 13 may interfere with the front side of the auricle.

In some embodiments, to avoid the earphone 10 from interfering with the ear of the user, when the sound-generating portion 11 and the abutment portion 12 have the non-contact structure as shown in FIG. 4, the length of the fifth connecting line CN may be from 13 mm to 17 mm. In some embodiments, to further avoid the sound-generating portion 11 from interfering with the tragus, the length of the fifth connecting line CN may be from 13.5 mm to 16 mm. In some embodiments, to further avoid the sound-generating portion 11 from interfering with the front side of the auricle, the length of the fifth connecting line CN may be from 14 mm to 15.5 mm. Merely by way of example, the length of the fifth connecting line CN may be 15 mm.

In some embodiments, when the sound-generating portion 11 and the abutment portion 12 have the contact structure shown in FIG. 6, the length of the fifth connecting line CN may be from 12 mm to 16 mm. For example, the length of the fifth connecting line CN may be 14.5 mm.

In some embodiments, to avoid interference between the earphone 10 and the ear of the user, when the abutment portion 12 and the sound-generating portion 11 have a structure that causes the first projection 11′ and the second projection 12′ to have an overlapping region, the length of the fifth connecting line CN may be from 12 mm to 16 mm. For example, the length of the fifth connecting line CN may be 12 mm, 13.4 mm, 14.5 mm, 16 mm, or other actual values within the range of 12 mm to 16 mm.

If an included angle (i.e., ∠NCO) between the fifth connecting line CN and the first connecting line OC is too large, the sound-generating portion 11 may interfere with the tragus. If the included angle (i.e., ∠NCO) between the fifth connecting line CN and the first connecting line OC is too small, the ear hook 13 may interfere with the front side of the auricle.

In some embodiments, to avoid interference between the earphone 10 and the ear of the user, when the sound-generating portion 11 and the abutment portion 12 have the non-contact structure shown in FIG. 4, the included angle between the fifth connecting line CN and the first connecting line OC may be from 13° to 27°. In some embodiments, to further avoid interference between the sound-generating portion 11 and the tragus, the included angle between the fifth connecting line CN and the first connecting line OC may be from 14° to 25°. In some embodiments, to further avoid interference between the sound-generating portion 11 and the front side of the auricle, the included angle between the fifth connecting line CN and the first connecting line OC may be from 18° to 23°. For example, the included angle between the fifth connecting line CN and the first connecting line OC may be 21°.

In some embodiments, when the sound-generating portion 11 and the abutment portion 12 have the contact structure shown in FIG. 6, the included angle between the fifth connecting line CN and the first connecting line OC may be from 12° to 26°. For example, the included angle between the fifth connecting line CN and the first connecting line OC may be 20°.

An extension line of the fifth connecting line CN intersects the first projection 11′ at an eighth feature point M. In some embodiments, the eighth feature point M may be considered as a point on the first projection 11′ farthest away from the second feature point C. In some embodiments, a direction of a connecting line between the second feature point C and the eighth feature point M is approximately oriented toward the ear canal opening of the user. In some embodiments, the sound outlet hole 111 is opened facing the ear canal opening of the user, and the eighth feature point M may be located near the centroid J of the sound outlet hole 111, or the eighth feature point M may coincide with the centroid J of the sound outlet hole 111 (as shown in FIG. 4).

A connecting line between the seventh feature point N and the eighth feature point M is defined as a sixth connecting line (i.e., a connecting line NM). A curve segment (i.e., an arc segment NM) of the first projection 11′ corresponding to the sixth connecting line NM has a fourth arc length. A ratio of the fourth arc length (i.e., a length of the arc segment NM) to a length of the sixth connecting line (i.e., the connecting line NM) is defined as a fourth arc-chord ratio. The fourth arc-chord ratio may reflect a shape of the first projection 11′, thereby reflecting a shape of the sound-generating portion 11.

In some embodiments, when the sound-generating portion 11 and the abutment portion 12 have the non-contact structure shown in FIG. 4, or when the sound-generating portion 11 and the abutment portion 12 have the contact structure shown in FIG. 6, the fourth arc-chord ratio may be from 1.4 to 1.7. This configuration causes the arc segment NM to approximate a semicircle, and the sixth connecting line NM may be considered as a diameter of the first projection 11′, which causes the sound-generating portion 11 to be spherical or approximately spherical, adapts the shape of the sound-generating portion 11 to the concha cavity, and improves wearing comfort of the earphone 10. In some embodiments, when the sound-generating portion 11 and the abutment portion 12 have the contact structure shown in FIG. 6, the fourth arc-chord ratio may be set to be greater than 1.7 and less than or equal to 2.0. This configuration causes the arc segment NM to approximate a semicircle, and the sixth connecting line NM may be considered as the diameter of the first projection 11′, making the sound-generating portion 11 to be spherical or approximately spherical, thereby adapting the shape of the sound-generating portion 11 to the concha cavity, and improving the wearing comfort of the earphone 10. For example, the fourth arc-chord ratio may be set to 1.75, 1.8, 2.0, or other actual values greater than 1.7 and less than or equal to 2.0.

In some embodiments, when the abutment portion 12 and the sound-generating portion 11 have a structure that causes the first projection 11′ and the second projection 12′ to have an overlapping region, the fourth arc-chord ratio may be from 1.4 to 1.7, or greater than 1.7 and less than or equal to 2.0. This configuration causes the arc segment NM to approximate a semicircle, and the sixth connecting line NM may be considered as the diameter of the first projection 11′, making the sound-generating portion 11 to be spherical or approximately spherical, thereby adapting the shape of the sound-generating portion 11 to the concha cavity, and improving the wearing comfort of the earphone 10. For example, in some embodiments, the fourth arc-chord ratio may be 1.4, 1.67, 1.7, or other actual values within the range of 1.4 to 1.7. As another example, the fourth arc-chord ratio may be set to 1.75, 1.8, 2.0, or other actual values greater than 1.7 and less than or equal to 2.0.

If a distance between the second feature point C and the eighth feature point M is too large, the sound-generating portion 11 may block the ear canal opening of the user or interfere with the tragus. If the distance between the second feature point C and the eighth feature point M is too small, the size of the sound-generating portion 11 may be affected, thereby affecting the sound listening effect, or the sound-generating portion 11 may interfere with the antihelix.

In some embodiments, when the sound-generating portion 11 and the abutment portion 12 have the non-contact structure shown in FIG. 4, to avoid the sound-generating portion 11 blocking the ear canal opening of the user, avoid the sound-generating portion 11 interfering with the tragus or the antihelix, and ensure the sound listening effect for the user, the distance between the second feature point C and the eighth feature point M may be from 26.5 mm to 29.5 mm. In some embodiments, to further avoid the sound-generating portion 11 interfering with the tragus or blocking the ear canal opening, the distance between the second feature point C and the eighth feature point M may be from 27 mm to 29 mm. In some embodiments, to further avoid the sound-generating portion 11 interfering with the antihelix and to ensure the size of the sound-generating portion 11, the distance between the second feature point C and the eighth feature point M may be from 27.5 mm to 28 mm. For example, the distance between the second feature point C and the eighth feature point M may be 27.7 mm.

In some embodiments, when the sound-generating portion 11 and the abutment portion 12 have the contact structure shown in FIG. 6, the distance between the second feature point C and the eighth feature point M may be from 27 mm to 30 mm. For example, the distance between the second feature point C and the eighth feature point M may be 27.8 mm. In some embodiments, when the sound-generating portion 11 and the abutment portion 12 have the contact structure shown in FIG. 6, the distance between the second feature point C and the eighth feature point M may be set to be greater than or equal to 25 mm and less than 27 mm. For example, in some embodiments, the distance between the second feature point C and the eighth feature point M may be set to 25 mm, 26 mm, 26.5 mm, or other actual values greater than or equal to 25 mm and less than 27 mm.

In some embodiments, when the abutment portion 12 and the sound-generating portion 11 have a structure that causes the first projection 11′ and the second projection 12′ to have an overlapping region, the distance between the second feature point C and the eighth feature point M may be from 27 mm to 30 mm, or greater than or equal to 25 mm and less than 27 mm. For example, in some embodiments, the distance between the second feature point C and the eighth feature point M may be set to 25 mm, 26 mm, 26.5 mm, or other actual values greater than or equal to 25 mm and less than 27 mm. As another example, in some embodiments, the distance between the second feature point C and the eighth feature point M may be 27 mm, 27.1 mm, 27.8 mm, 30 mm, or other actual values within the range of 27 mm to 30 mm.

In some embodiments, a third auxiliary line L₆ is drawn through the second feature point C toward a side biased toward the second projection 12′. The third auxiliary line L₆ has at least one intersection point with a contour of the second projection 12′. An intersection point farthest away from the second feature point C among the at least one intersection point is defined as a ninth feature point D. A connecting line CD between the ninth feature point D and the second feature point C serves as a sixth connecting line. In some embodiments, the ninth feature point D is a point on the abutment portion 12 farthest away from the second feature point C.

In some embodiments, a relative position between the ninth feature point D and the second feature point C affects a position or an attitude of the abutment portion 12 in the wearing state. If a distance between the ninth feature point D and the second feature point C (i.e., a length of the sixth connecting line CD) is too large, or if a third included angle (i.e., ∠OCD) between the sixth connecting line CD and the first connecting line OC is too large, the abutment portion 12 may interfere with the head skin at the back of the auricle of the user in the wearing state. If the distance between the ninth feature point D and the second feature point C (i.e., the length of the sixth connecting line CD) is too small, or if the third included angle (i.e., ∠OCD) between the sixth connecting line CD and the first connecting line OC is too small, the abutment portion 12 may excessively compress tissue at the back of the auricle of the user.

In some embodiments, when the sound-generating portion 11 and the abutment portion 12 have the non-contact structure shown in FIG. 4, to avoid the abutment portion 12 excessively compressing the ear and to avoid the abutment portion 12 interfering with the head skin of the user, the length of the sixth connecting line CD may be less than 22 mm, and the third included angle between the sixth connecting line CH and the first connecting line OC may be from 18° to 22°. In some embodiments, to further avoid the abutment portion 12 excessively compressing the ear, the length of the sixth connecting line CD may be greater than 17 mm. That is to say, the length of the sixth connecting line CD may be from 17 mm to 22 mm, and the third included angle between the sixth connecting line CH and the first connecting line OC may be from 18.2° to 19.8°. In some embodiments, to further avoid the abutment portion 12 interfering with the head skin of the user, the length of the sixth connecting line CD may be from 18.5 mm to 20 mm, and the third included angle between the sixth connecting line CH and the first connecting line OC may be from 18.5° to 19.2°. For example, the length of the fifth connecting line CD may be 19.8 mm, and the third included angle between the sixth connecting line CH and the first connecting line OC may be 19°.

In some embodiments, when the sound-generating portion 11 and the abutment portion 12 have the contact structure shown in FIG. 6, the length of the sixth connecting line CD may be from 16 mm to 21 mm, and the third included angle between the sixth connecting line CH and the first connecting line OC may be from 18° to 20°. For example, the length of the sixth connecting line CD may be 20.6 mm, and the third included angle between the sixth connecting line CH and the first connecting line OC may be 21°. In some embodiments, when the sound-generating portion 11 and the abutment portion 12 have the contact structure shown in FIG. 6, the third included angle between the sixth connecting line CH and the first connecting line OC may be set to be greater than or equal to 15° and less than 18°, and the length of the sixth connecting line CD may be from 16 mm to 21 mm, or greater than 21 mm and less than or equal to 23 mm. For example, in some embodiments, the third included angle between the sixth connecting line CH and the first connecting line OC may be set to 15°, 16°, 17°, or other actual values greater than or equal to 15° and less than 18°. For example, in some embodiments, the length of the sixth connecting line CD may be 16 mm, 20.6 mm, 21 mm, or the like, which are actual values within a range of 16 mm to 21 mm. For example, in some embodiments, the length of the sixth connecting line CD may be 22 mm, 22.5 mm, 23 mm, or the like, which are actual values greater than 21 mm and less than or equal to 23 mm. Merely by way of example, in some embodiments, the third included angle between the sixth connecting line CH and the first connecting line OC may be set to 17°, and the length of the sixth connecting line CD may be set to 20.8 mm.

In some embodiments, when the abutment portion 12 and the sound-generating portion 11 have a structure such that the first projection 11′ and the second projection 12′ have an overlapping region, the third included angle between the sixth connecting line CH and the first connecting line OC may be from 18° to 20°, or greater than or equal to 15° and less than 18°, and the length of the sixth connecting line CD may be from 16 mm to 21 mm, or greater than 21 mm and less than or equal to 23 mm. For example, in some embodiments, the third included angle between the sixth connecting line CH and the first connecting line OC may be set to 15°, 16°, 17°, or the like, which are actual values greater than or equal to 15° and less than 18°. For example, the third included angle between the sixth connecting line CH and the first connecting line OC may be set to 18°, 19°, 20°, or the like, which are actual values within a range of 18° to 20°. For example, in some embodiments, the length of the sixth connecting line CD may be 16 mm, 20.6 mm, 21 mm, or the like, which are actual values within a range of 16 mm to 21 mm. For example, in some embodiments, the length of the sixth connecting line CD may be 22 mm, 22.5 mm, 23 mm, or the like, which are actual values greater than 21 mm and less than or equal to 23 mm. Merely by way of example, in some embodiments, the third included angle between the sixth connecting line CH and the first connecting line OC may be set to 17°, and the length of the sixth connecting line CD may be set to 20.8 mm.

It should be noted that the data related to the earphone 10 in the above-mentioned FIG. 2 to FIG. 6 are all data of the earphone 10 in a natural state when the earphone 10 is not worn. FIG. 4 and FIG. 6 respectively represent two different natural states of the earphone 10.

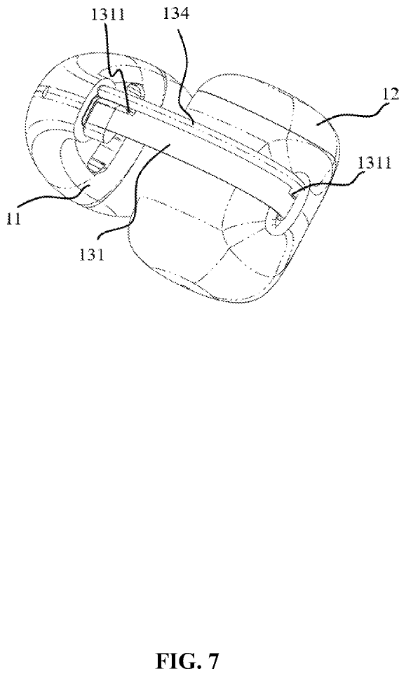

FIG. 7 is a schematic diagram of an internal structure of an exemplary ear hook according to some embodiments of the present disclosure. Referring to FIG. 7, in some embodiments, the ear hook 13 includes a metal sheet 131 and a flexible layer (not shown in the drawing) wrapping an outer side of the metal sheet 131. The metal sheet 131 is configured to connect the sound-generating portion 11 and the abutment portion 12. The flexible layer is configured to protect the metal sheet 131. In some embodiments, a wire 134 for electrical signal connection between the sound-generating portion 11 and the abutment portion 12 is further arranged in the flexible layer. In some embodiments, to reduce determination calculation difficulty and improve efficiency, an influence of the wire 134 may not be considered when determining the first symmetry plane S₁ of the ear hook 13.

In some embodiments, the metal sheet 131 has high support strength, good fatigue resistance, and a long service life. When the ear hook 13 is stretched, the metal sheet 131, which is a support structure of the ear hook 13, is not prone to torsion, which facilitates wearing of the sound-generating portion 11 and the abutment portion 12, and can reduce a possibility of the ear hook 13 being damaged by torsion, thereby improving the service life of the ear hook 13.

In some embodiments, the metal sheet 131 may include an elastic metal such as a titanium sheet to facilitate adjustment of the ear hook 13.

In some embodiments, the metal sheet 131 is located at a center of the ear hook 13, and the first symmetry plane S₁ may coincide with a symmetry plane of the metal sheet 131 in a width direction. In some embodiments, if a width dimension of the metal sheet 131 is too large, the size of the ear hook 13 becomes too large, and the ear hook 13 may interfere with the ear of the user, thereby affecting the wearing effect of the earphone 10. If the width dimension of the metal sheet 131 is too small, the metal sheet 131 has poor anti-torsion performance, and the metal sheet 131 may twist during stretching of the ear hook 13, thereby affecting the shape of the ear hook 13 and the wearing effect of the earphone 10.

In some embodiments, to avoid interference between the ear hook 13 and the ear of the user and to enable the ear hook 13 to maintain its shape during stretching, thereby ensuring the wearing effect of the earphone 10, the width dimension of the metal sheet 131 may be from 1.5 mm to 3 mm. In some embodiments, to further avoid interference between the ear hook 13 and the ear of the user, the width dimension of the metal sheet 131 may be from 1.7 mm to 2.7 mm. In some embodiments, to further prevent the metal sheet 131 from twisting during stretching of the ear hook 13, improve the service life of the metal sheet 131, and maintain the shape of the ear hook 13, the width dimension of the metal sheet 131 may be from 2 mm to 2.5 mm.

In some embodiments, to provide the ear hook 13 with sufficient support strength, a thickness dimension of the metal sheet 131 may be from 0.15 mm to 0.3 mm. In some embodiments, to enable the metal sheet 131 to provide support for the ear hook 13, the thickness dimension of the metal sheet 131 may be from 0.2 mm to 0.25 mm.

The width dimension of the metal sheet 131 refers to a dimension of the metal sheet 131 in a direction perpendicular to the first symmetry plane S₁. The thickness dimension of the metal sheet 131 refers to a dimension of the metal sheet 131 in a direction within the first symmetry plane S₁ and perpendicular to a length direction of the metal sheet 131.

In some embodiments, a flexible circuit board may be disposed on the metal sheet 131 to facilitate wiring and circuit arrangement. In some embodiments, two ends of the metal sheet 131 connected to the sound-generating portion 11 and the abutment portion 12 are respectively provided with recesses 1311, as shown in FIG. 7. The arrangement of the recesses 1311 facilitates glue sealing during mold forming of the ear hook 13.

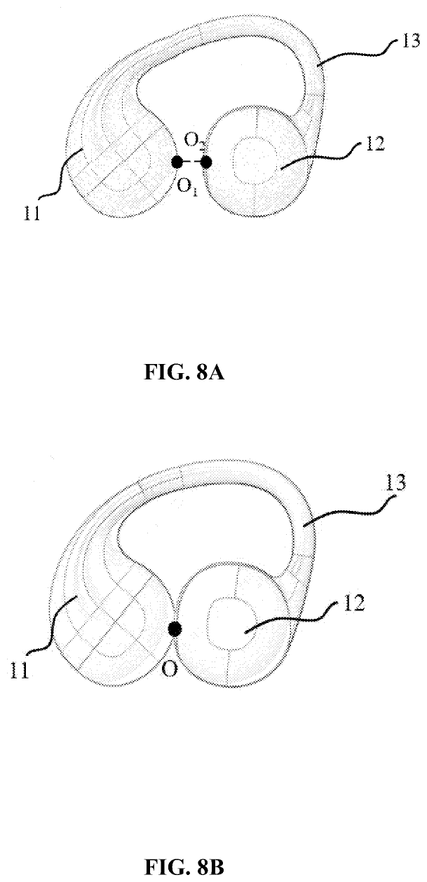

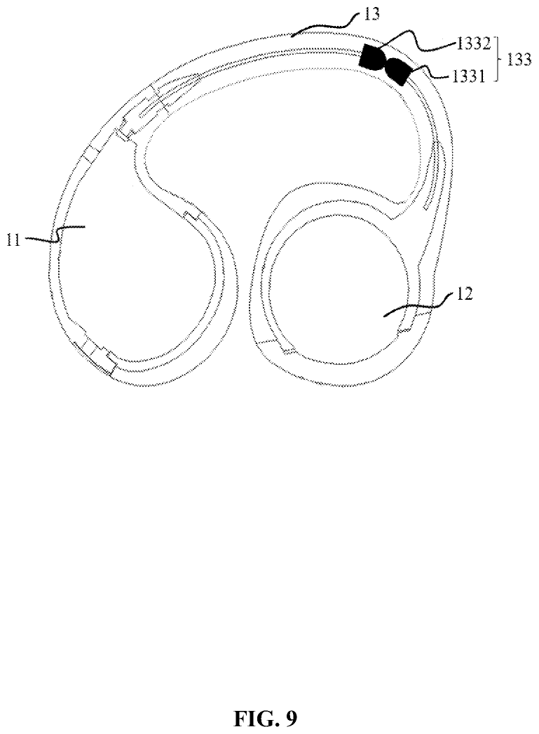

FIG. 8A is a schematic diagram of an exemplary earphone in a first stable position according to some embodiments of the present disclosure. FIG. 8B is a schematic diagram of the exemplary earphone in a second stable position according to some embodiments of the present disclosure. FIG. 9 is a schematic diagram of an exemplary bistable structure according to some embodiments of the present disclosure. Referring to FIG. 8A, FIG. 8B, and FIG. 9, in some embodiments, a bistable structure 133 is arranged on the metal sheet 131. The bistable structure 133 is configured to enable the ear hook 13 to have a first stable position (as shown in FIG. 8A) and a second stable position (as shown in FIG. 8B). By controlling the ear hook 13 to switch between the first stable position and the second stable position, wearing and removal of the earphone 10 can be facilitated. In some embodiments, the bistable structure 133 is arranged near the second feature point C. Because a smoothness of the inner contour curve of the third projection 13′ on two sides of the second feature point C is different, arranging the bistable structure 133 near the second feature point C can create a significant difference between the first stable position and the second stable position, thereby facilitating the wearing or removal of the earphone 10.

In some embodiments, the first stable position facilitates the user to wear the earphone 10. The second stable position enables the earphone 10 to be stably clamped on the ear of the user. In some embodiments, a length of the shortest connecting line O₁O₂ corresponding to the first stable position is greater than a length of the shortest connecting line O₁O₂ corresponding to the second stable position, to facilitate clamping and removal of the earphone 10. When the sound-generating portion 11 contacts the abutment portion 12, the length of the shortest connecting line O₁O₂ may be considered as 0. In some embodiments, to allow the helix of the user to be placed between the sound-generating portion 11 and the abutment portion 12 so that the earphone 10 enters a clamping position, the length of the shortest connecting line O₁O₂ corresponding to the first stable position may be greater than or equal to a thickness of the helix of the user. In some embodiments, to enable the sound-generating portion 11 and the abutment portion 12 to clamp the helix of the user so that the earphone 10 is stably worn, the length of the shortest connecting line O₁O₂ corresponding to the second stable position may be less than the thickness of the helix of the user. In some embodiments, when the ear hook 13 is in the first stable position, a distance between the sound-generating portion 11 and the abutment portion 12 (e.g., the length of the shortest connecting line O₁O₂) is greatest. When the ear hook 13 is in the second stable position, the distance between the sound-generating portion 11 and the abutment portion 12 (e.g., the length of the shortest connecting line O₁O₂) is smallest. In some embodiments, the distance between the sound-generating portion 11 and the abutment portion 12 (e.g., the length of the shortest connecting line O₁O₂) when the earphone 10 is in the wearing state is greater than the distance between the sound-generating portion 11 and the abutment portion 12 (e.g., the length of the shortest connecting line O₁O₂) when the ear hook 13 is in the second stable position.

In some embodiments, when the sound-generating portion 11 and the abutment portion 12 have the non-contact structure shown in FIG. 4, and the ear hook 13 is in the first stable position, the earphone 10 may be in a positional state as shown in FIG. 4, and the length of the shortest connecting line O₁O₂ corresponding to the first stable position is greater than the length of the shortest connecting line O₁O₂ corresponding to the second stable position.

In some embodiments, when the sound-generating portion 11 and the abutment portion 12 have the contact structure shown in FIG. 6, and the ear hook 13 is in the second stable position, the earphone 10 may be in a positional state as shown in FIG. 6. When the ear hook 13 is in the first stable position, the first projection 11′ does not contact the second projection 12′, i.e., the sound-generating portion 11 does not contact the abutment portion 12.

In some embodiments, when the user is preparing to wear the earphone 10, if the ear hook 13 is in the first stable position, the user may hold the earphone 10 with one hand and place the earphone 10 at a wearing position on the ear of the user, then apply a force to the earphone 10 with the same hand (e.g., different fingers respectively abutting an outer contour of the sound-generating portion 11 and an outer contour of the abutment portion 12 to bring the sound-generating portion 11 and the abutment portion 12 closer together) to cause the ear hook 13 to transition from the first stable position to the second stable position, thereby achieving clamped wearing of the earphone 10.

In some embodiments, when the user is preparing to wear the earphone 10, if the ear hook 13 is in the second stable position, the user may pull the abutment portion 12 and the sound-generating portion 11 apart to cause the ear hook 13 to transition from the second stable position to the first stable position, thereby facilitating subsequent wearing.

In some embodiments, when the user is preparing to remove the earphone 10 worn on the ear, the user may pull the abutment portion 12 and the sound-generating portion 11 apart to cause the ear hook 13 to transition from a position in the wearing state to the first stable position, thereby facilitating removal of the earphone 10.

Referring to FIG. 9, in some embodiments, the bistable structure 133 may include a protruding portion 1331 and an abutting part 1332. The abutting part 1332 abuts against a protruding point (not shown in the drawing) of the protruding portion 1331. When the abutting part 1332 abuts against the protruding point of the protruding portion 1331, a pressure between the abutting part 1332 and the protruding portion 1331 is maximum, and the abutting part 1332 and the protruding portion 1331 are in an unstable state. When the abutting part 1332 abuts against two sides of the protruding point on the protruding portion 1331, the pressure between the abutting part 1332 and the protruding portion 1331 decreases, and the abutting part 1332 and the protruding portion 1331 are in a stable state. That is to say, when the abutting part 1332 abuts against the two sides of the protruding point of the protruding portion 1331 respectively, a first stable position and a second stable position are formed. In some embodiments, when the abutting part 1332 abuts against a side of the protruding point on the protruding portion 1331 away from the abutment portion 12 (i.e., a side close to the outer contour of the ear hook 13), the ear hook 13 is in the first stable position. When the abutting part 1332 abuts against a side of the protruding point on the protruding portion 1331 close to the abutment portion 12 (i.e., a side close to the inner contour of the ear hook 13), the ear hook 13 is in the second stable position.

In some embodiments, a design different from the bistable structure 133 may be adopted to achieve switching of the earphone 10 between the first stable position and the second stable position. For example, the bistable structure may be a two-dimensional curved surface bistable structure. By way of example, the two-dimensional curved surface bistable structure may be formed by superimposing two thin sheets with a 90-degree included angle of strain to form a bistable structure with different bending modes. As another example, the bistable structure 133 may be implemented by designing a smart material (e.g., a liquid crystal, a hydrogel, a shape memory polymer) into a beam structure. By changing driving conditions of the smart material (e.g., changing a magnetic field or an electric field applied to the material), switching of the earphone 10 between the two stable positions can be achieved. Specifically, a button for switching the stable positions may be provided on the earphone 10, and an input of the button corresponds to the change of the driving conditions described above.

The foregoing has described the basic concepts. It is apparent to those skilled in the art that the foregoing detailed disclosure are merely examples and do not constitute a limitation to the present disclosure. Although not explicitly stated here, those skilled in the art may make various modifications, improvements and amendments to the present disclosure. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. In addition, some features, structures, or features in the present disclosure of one or more embodiments may be appropriately combined.

Similarly, it should be noted that in the foregoing description of embodiments of the present disclosure, various features are sometimes grouped together in a single embodiment, drawing, or description thereof for the purpose of streamlining the disclosure aiding in the understanding of one or more of the various embodiments. However, this way of disclosure does not mean that the present disclosure object requires more features than the features mentioned in the claims. Rather, claimed subject matter may lie in less than all features of a single foregoing disclosed embodiment.

In some embodiments, numbers describing quantities of components or attributes are used. It should be understood that such numbers used in the description of the embodiments are modified by the modifiers “about,” “approximately,” or “substantially” in some examples. Unless otherwise stated, “about,” “approximately,” or “substantially” indicates that the stated number allows a variation of ±20%. Accordingly, in some embodiments, the numerical parameters used in the specification and the claims are approximate values, and the approximate values may vary according to the characteristics required by individual embodiments. In some embodiments, the numerical parameters should consider the prescribed number of significant digits and adopt the manner of general digit retention. Although the numerical ranges and parameters used to confirm the breadth of the scope in some embodiments of the present disclosure are approximate values, in specific embodiments, the setting of such numerical values is as precise as possible within a feasible range.

Finally, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An ear-clip earphone, comprising: a sound-generating portion configured to be located in a concha cavity of a user and to contact an inner wall of the concha cavity, wherein the sound-generating portion includes:
a housing, wherein an accommodating chamber is provided in the housing;
a sound-generating assembly accommodated in the accommodating chamber and configured to convert an electrical signal into an audio signal;
a sound outlet hole located on the housing and configured to guide out a sound generated by the sound-generating assembly;
an abutment portion configured to abut against a back of an ear of the user, wherein a battery is disposed in the abutment portion;
an ear hook configured to bypass an antihelix and a helix of the user and connect the sound-generating portion and the abutment portion, the ear hook having a first symmetry plane, wherein the housing forms a first projection on the first symmetry plane, the abutment portion forms a second projection on the first symmetry plane, the ear hook forms a third projection on the first symmetry plane, and the third projection includes an inner contour curve; wherein,
the first projection and the second projection are in contact with each other, and the first projection and the second projection have a first common tangent between the first projection and the second projection, the first common tangent is tangent to the first projection and the second projection at a first tangent point, and the first tangent point serves as a first feature point; or,
the first projection and the second projection have an overlapping region, an outer contour of the first projection and an outer contour of the second projection have two intersection points, and a midpoint of a connecting line between the two intersection points serves as the first feature point;
a point on the inner contour curve farthest from the first feature point serves as a second feature point, and a distance between the first feature point and the second feature point ranges from 16.5 millimeters (mm) to 20.5 mm, or the distance between the first feature point and the second feature point is greater than or equal to 12 mm and less than 16.5 mm.

2. The ear-clip earphone according to claim 1, wherein a side of the first projection away from the third projection and a side of the second projection away from the third projection have a second common tangent, the second common tangent is tangent to the first projection at a second tangent point, the second common tangent is tangent to the second projection at a third tangent point, a connecting line between the second tangent point and the third tangent point is defined as a reference connecting line, and in a direction defined by the reference connecting line, the abutment portion and the second feature point are located on a same side of the first feature point.

3. The ear-clip earphone according to claim 2, wherein in the direction defined by the reference connecting line, the distance between the first feature point and the second feature point ranges from 7.5 mm to 10 mm, or the distance between the first feature point and the second feature point is greater than or equal to 5 mm and less than 7.5 mm.

4. The ear-clip earphone according to claim 2, wherein a connecting line between the first feature point and the second feature point is defined as a first connecting line, and an included angle between the first connecting line and the reference connecting line ranges from 45° to 60°, or the included angle between the first connecting line and the reference connecting line is greater than 60° and less than or equal to 70°.

5. The ear-clip earphone according to claim 2, wherein a centroid of the second projection is defined as a third feature point, and in the direction defined by the reference connecting line, the second feature point is farther away from the first feature point than the third feature point.

6. The ear-clip earphone according to claim 5, wherein a connecting line between the first feature point and the second feature point is defined as a first connecting line, and an included angle between a connecting line between the first feature point and the third feature point and the first connecting line ranges from 45° to 65°.

7. The ear-clip earphone according to claim 2, wherein a connecting line between the first feature point and the second feature point is defined as a first connecting line, a first auxiliary line is drawn through the second feature point toward a side biased toward the first projection, a first included angle between the first auxiliary line and the first connecting line has a first preset value range, an intersection point between the first auxiliary line and a curve segment of the inner contour curve that is connected to the first projection is defined as a fourth feature point, a connecting line between the fourth feature point and the second feature point is defined as a second connecting line, and the first preset value range is from 27° to 37°, or the first preset value range is greater than 37° and less than or equal to 50°.

8. The ear-clip earphone according to claim 7, wherein a length of the second connecting line ranges from 15.5 mm to 21.5 mm, or the length of the second connecting line is greater than or equal to 12.00 mm and less than 15.5 mm.

9. The ear-clip earphone according to claim 7, wherein a portion of the inner contour curve corresponding to the second connecting line has a first arc length, a ratio of the first arc length to a length of the second connecting line is defined as a first arc-chord ratio, and the first arc-chord ratio ranges from 1.10 to 1.25, or the first arc-chord ratio is greater than or equal to 1.05 and less than 1.10.

10. The ear-clip earphone according to claim 7, wherein a portion of the inner contour curve corresponding to the second connecting line is defined as a first arc segment, and a distance from the second connecting line to the first arc segment is not greater than 3.2 mm, or the distance from the second connecting line to the first arc segment is not greater than 7.5 mm.

11. (canceled)

12. The ear-clip earphone according to claim 1, wherein a second auxiliary line is drawn through the second feature point toward a side biased toward the second projection, a second included angle between the second auxiliary line and the first connecting line has a second preset value range, an intersection point between the second auxiliary line and a curve segment of the inner contour curve that is connected to the second projection is defined as a fifth feature point, a connecting line between the fifth feature point and the second feature point is defined as a fourth connecting line, and the second preset value range is from 34° to 49°, or the second preset value range is greater than or equal to 20° and less than 34°.

13. The ear-clip earphone according to claim 12, wherein a length of the fourth connecting line is from 7.2 mm to 9.2 mm.

14. The ear-clip earphone according to claim 12, wherein a portion of the inner contour curve corresponding to the fourth connecting line has a third arc length, a ratio of the third arc length to a length of the fourth connecting line is defined as a third arc-chord ratio, and the third arc-chord ratio is from 1.11 to 1.24, or the third arc-chord ratio is greater than 1.24 and less than or equal to 1.4.

15. The ear-clip earphone according to claim 1, wherein a parallel line parallel to the reference connecting line is drawn through the first feature point, an intersection point between the parallel line and a contour of the first projection serves as a sixth feature point, and a distance between the first feature point and the sixth feature point is from 10.5 mm to 15.5 mm, or the distance between the first feature point and the sixth feature point is greater than 15.5 mm and less than or equal to 17 mm.

16. The ear-clip earphone according to claim 1, wherein a connecting line between the first feature point and the second feature point is defined as a first connecting line, a point on the first projection closest to the second feature point serves as a seventh feature point, a connecting line between the seventh feature point and the second feature point serves as a fifth connecting line, a length of the fifth connecting line is from 12 mm to 16 mm, and an included angle between the fifth connecting line and the first connecting line is from 12° to 26°.

17. The ear-clip earphone according to claim 16, wherein an extension line of the fifth connecting line intersects the first projection at an eighth feature point, a connecting line between the seventh feature point and the eighth feature point is defined as a sixth connecting line, a curve segment of the first projection corresponding to the sixth connecting line has a fourth arc length, a ratio of the fourth arc length to a length of the sixth connecting line is defined as a fourth arc-chord ratio, and the fourth arc-chord ratio is from 1.4 to 1.7, or the fourth arc-chord ratio is greater than 1.7 and less than or equal to 2.0.

18. (canceled)

19. The ear-clip earphone according to claim 1, wherein a connecting line between the first feature point and the second feature point is defined as a first connecting line, a third auxiliary line is drawn through the second feature point toward a side biased toward the second projection, a third included angle between the third auxiliary line and the first connecting line has a third preset value range, the third auxiliary line and a contour of the second projection have at least one intersection point, an intersection point farthest from the second feature point among the at least one intersection point is defined as a ninth feature point, a connecting line between the second feature point and the ninth feature point is defined as a sixth connecting line, the third preset value range is from 18° to 20° or greater than or equal to 15° and less than 18°, and a length of the sixth connecting line is from 16 mm to 21 mm, or the length of the sixth connecting line is greater than 21 mm and less than or equal to 23 mm.

20. The ear-clip earphone according to claim 1, wherein in a wearing state, a point on the sound-generating portion corresponding to the first feature point is covered by the concha cavity.

21. The ear-clip earphone according to claim 1, wherein the ear hook includes a metal sheet and a flexible layer wrapping an outer side of the metal sheet, two ends of the metal sheet in a length direction of the metal sheet are respectively connected to the housing and the contact portion, and a width dimension of the metal sheet ranges from 1 mm to 3 mm, and a thickness of the metal sheet ranges from 0.15 mm to 0.3 mm.

22. The ear-clip earphone according to claim 21, wherein the metal sheet is provided with a bistable structure, the bistable structure is configured to enable the ear hook to have a first stable position and a second stable position, when the ear hook is in the first stable position, the first projection does not contact the second projection; and when the ear hook is in the second stable position, the first projection contacts the second projection.

23. (canceled)
